(19) United States
(12) Patent Application Publication
(10) Pub. No.: US 2026/0046530 A1
(43) Pub. Date: Feb. 12, 2026

(54) IMAGE SENSOR AND ELECTRONIC APPARATUS INCLUDING THE SAME

(71) Applicant: SAMSUNG ELECTRONICS CO., LTD., Suwon-si (KR)

(72) Inventors: Soongeun Jang, Suwon-si (KR); Sookyoung Roh, Suwon-si (KR); Junho Lee, Suwon-si (KR)

(73) Assignee: SAMSUNG ELECTRONICS CO., LTD., Suwon-si (KR)

(21) Appl. No.: 19/185,944

(22) Filed: Apr. 22, 2025

(30) Foreign Application Priority Data
Aug. 9, 2024 (KR) 10-2024-0107164

(51) Int. Cl. H04N 25/13; H04N 25/77

(52) U.S. Cl. CPC H04N 25/134; H04N 25/77

(57) ABSTRACT

Provided is an image sensor including a sensor substrate including a plurality of unit pixel groups in two dimensions in a first direction and a second direction, each unit pixel group including a plurality of pixels configured to detect light, and an optical element on the sensor substrate and configured to focus incident light onto each of the plurality of pixels that respectively includes a first unit including a red pixel, two green pixels, and a blue pixel, which are arranged in a 2×2 format in the first direction and the second direction, the two green pixels being adjacent to each other in a diagonal direction, and a second unit, a third unit, and a fourth unit having structures of the first unit rotated by 90, 180, and 270 degrees, respectively, with a third direction perpendicular to the first direction and the second direction.

### CROSS-REFERENCE TO RELATED APPLICATION

This application claims priority to Korean Patent Application No. 10-2024-0107164, filed on Aug. 9, 2024, in the Korean Intellectual Property Office, the disclosure of which is incorporated herein in its entirety by reference.

### BACKGROUND

### 1. Field

Embodiments of the present disclosure relate to an image sensor and an electronic apparatus including the same.

### 2. Description of Related Art

General image sensors have a structure in which pixels detecting light of different colors are periodically arranged, and thus, it is not possible to obtain the same color information from all areas on the image sensor. Accordingly, resolution may deteriorate due to undersampling, and artifacts may occur in an image processing process to reconstruct lost color information.

A color image sensor using a Bayer color filter array (CFA) has been widely used because the color image sensor may obtain three primary colors of RGB of relatively high image quality at relatively low processing costs. In this structure, while one pixel may receive only one color, two insufficient colors may be obtained by an interpolation method using surrounding colors. Such processing is referred to as a demosaicing process. As one pixel can receive only one color in a Bayer CFA, a mosaic pattern having a repeated 2×2 structure is obtained, and the mosaic pattern is demosaiced. However, an existing image sensor uses interpolation processing using demosaicing to produce RGB colors, and thus, there is a limitation in capturing a high image quality image. This is because resolving power is reduced by the interpolation processing.

As a structure to address the above defects, there is a Foveon image sensor that may receive all RGB colors by one pixel. A Foveon image sensor has a structure in which three photodiodes are vertically stacked, and receives incident light from the top photodiode to the bottom photodiode in order from light with the shortest wavelength to light with the longest wavelength. However, this method has a disadvantage of having a lot of color mixing between RGB. In other words, instead of RGB with relatively high accuracy (colors separated into each color area on the CIE color chart), a red color with partially mixed green color may be obtained, and for green and blue as well, colors mixed with other colors may be obtained.

### SUMMARY

One or more embodiments provide an image sensor configured to perform an image processing process without demosaicing, and an electronic apparatus including the image sensor.

Additional aspects will be set forth in part in the description which follows and, in part, will be apparent from the description, or may be learned by practice of the one or more embodiments.

According to an aspect of one or more embodiments, there is provided an image sensor including a sensor substrate including a plurality of unit pixel groups in two dimensions in a first direction and a second direction, each unit pixel group among the plurality of unit pixels groups including a plurality of pixels configured to detect light, and an optical element on the sensor substrate and configured to focus incident light onto each pixel of the plurality of pixels, wherein each unit pixel group of the plurality of unit pixel groups includes a first unit including a red pixel, two green pixels, and a blue pixel, which are in a 2×2 format in the first direction and the second direction, the two green pixels being adjacent to each other in a diagonal direction, a second unit having a structure of the first unit rotated by 90 degrees with respect to a third direction perpendicular to the first direction and the second direction as an axis of rotation, a third unit having a structure of the first unit rotated by 180 degrees with respect to the third direction as an axis of rotation, and a fourth unit having a structure of the first unit rotated by 270 degrees with respect to the third direction as an axis of rotation.

The image sensor may be configured to obtain pieces of information with respect to red light, green light, and blue light, each having same space information, from each of the first unit, the second unit, the third unit, and the fourth unit.

Each pixel group of the plurality of unit pixel groups may include the first unit, the second unit, the third unit, and the fourth unit, and the first unit, the second unit, the third unit, and the fourth unit may be in a 2×2 format in the first direction and the second direction.

Each unit pixel group of the plurality of unit pixel groups may include nine units from among the first unit, the second unit, the third unit, and the fourth unit, the nine units including one or more of each of the first unit, the second unit, the third unit, and the fourth unit, and the nine units may be in a 3×3 format in the first direction and the second direction, identical units among the first unit, the second unit, the third unit, and the fourth unit being spaced apart from each other in the first direction or the second direction.

Each unit pixel group of the plurality of unit pixel groups may include sixteen units from among the first unit, the second unit, the third unit, and the fourth unit, the sixteen units including one or more of each of the first unit, the second unit, the third unit, and the fourth unit, and the sixteen units may be in a 4×4 format in the first direction and the second direction, identical units among the first unit, the second unit, the third unit, and the fourth unit being spaced apart from each other in the first direction or the second direction.

The optical element may include a nano optical lens array, wherein the nano optical lens array may include a first unit structure, a second unit structure, a third unit structure, and a fourth unit structure corresponding to the first unit, the second unit, the third unit, and the fourth unit, respectively, wherein each of the first unit structure, the second unit structure, the third unit structure, and the fourth unit structure may include a plurality of areas corresponding to the plurality of pixels, respectively, and each of the first unit structure, the second unit structure, the third unit structure, and the fourth unit structure may include a plurality of nanostructures configured to color-separate incident light to be focused on each pixel of the plurality of pixels.

The plurality of nanostructures may be configured such that no light exchange occurs between the first unit structure, the second unit structure, the third unit structure, and the fourth unit structure, and color separation and focusing may occur independently within each of the first unit structure, the second unit structure, the third unit structure, and the fourth unit structure.

The image sensor may further include an optical diffuser on the nano optical lens array.

The image sensor may further include a color filter array between the nano optical lens array and the sensor substrate.

The red pixel may include a red photodiode configured to selectively absorb light of a red wavelength band and has a first width in one of the first direction and the second direction, wherein each green pixel among the two green pixels may include a green photodiode configured to selectively absorb light of a green wavelength band and has a second width in one of the first direction and the second direction, wherein the blue pixel may include a blue photodiode configured to selectively absorb light of a blue wavelength band and has a third width in one of the first direction and the second direction, and at least two widths among the first width, the second width, and the third width may be different from each other.

Each unit pixel group of the plurality of unit pixel groups may include the first unit, the second unit, the third unit, and the fourth unit, and wherein the first unit, the second unit, the third unit, and the fourth unit may be in a 2×2 format in the first direction and the second direction.

Each unit pixel group of the plurality of unit pixel groups may include nine units from among the first unit, the second unit, the third unit, and the fourth unit, the nine units including one or more of each of the first unit, the second unit, the third unit, and the fourth unit, and the nine units may be in a 3×3 format in the first direction and the second direction, identical units among the first unit, the second unit, the third unit, and the fourth unit being spaced apart from each other in the first direction or the second direction.

Each unit pixel group of the plurality of unit pixel groups may include sixteen units from among the first unit, the second unit, the third unit, and the fourth unit, the sixteen units including one or more of each of the first unit, the second unit, the third unit, and the fourth unit, and wherein the sixteen units may be in a 4×4 format in the first direction and the second direction, identical units among the first unit, the second unit, the third unit, and the fourth unit being spaced apart from each other in the first direction or the second direction.

Among the first width, the second width, and the third width, the first width may be the greatest, and the second width may be the smallest.

The image sensor may be configured to generate one luminance signal by adding all of an output of the red pixel, outputs of the two green pixels, and an output of the blue pixel, generate a first color signal by subtracting the outputs of the two green pixels from the output of the blue pixel, and generate a second color signal by subtracting the outputs of the two green pixels from the output of the red pixel, in the first unit of each of the plurality of unit pixel groups.

The luminance signal, the first color signal, and the second color signal may be generated without performing demosaicing processing on the output of the red pixel, the outputs of the two green pixels, and the output of the blue pixel, in the first unit of each unit pixel group of the plurality of unit pixel groups.

According to an aspect of one or more embodiments, there is provided an electronic apparatus including a lens assembly configured to form an optical image of an object, an image sensor configured to convert the optical image formed by the lens assembly into an electrical signal, and a processor configured to process a signal generated by the image sensor, wherein the image sensor includes a sensor substrate including a plurality of unit pixel groups in two dimensions in a first direction and a second direction, each unit pixel group of the plurality of unit pixel groups including a plurality of pixels configured to detect light, and an optical element arranged on the sensor substrate and focusing incident light onto each pixel of the plurality of pixels, and wherein each unit pixel group of the plurality of unit pixel groups includes a first unit including a red pixel, two green pixels, and a blue pixel, which are in a 2×2 format in the first direction and the second direction, the two green pixels being adjacent to each other in a diagonal direction, a second unit having a structure of the first unit rotated by 90 degrees with respect to a third direction perpendicular to the first direction and the second direction as an axis of rotation, a third unit having a structure of the first unit rotated by 180 degrees with respect to the third direction as an axis of rotation, and a fourth unit having a structure of the first unit rotated by 270 degrees with respect to the third direction as an axis of rotation.

The image sensor may be further configured to generate one luminance signal by adding all of an output of the red pixel, outputs of the two green pixels, and an output of the blue pixel, generate a first color signal by subtracting the outputs of the two green pixels from the output of the blue pixel, and generate a second color signal generated by subtracting the outputs of the two green pixels from the output of the red pixel, in the first unit of each of the plurality of unit pixel groups.

The image sensor may be further configured to generate the luminance signal, the first color signal, and the second color signal without performing demosaicing processing on the output of the red pixel, the outputs of the two green pixels, and the output of the blue pixel, in the first unit of each unit pixel group of the plurality of unit pixel groups.

The red pixel may include a red photodiode configured to selectively absorb light of a red wavelength band and has a first width in one or the first direction and the second direction, wherein each green pixel among the two green pixels may include a green photodiode configured to selectively absorb light of a green wavelength band and has a second width in one of the first direction and the second direction, wherein the blue pixel may include a blue photodiode configured to selectively absorb light of a blue wavelength band and has a third width in one of the first direction and the second direction, and wherein at least two widths among the first width, the second width, and the third width are different from each other.

### BRIEF DESCRIPTION OF DRAWINGS

These and/or other aspects will become apparent and more readily appreciated from the following description of the embodiments, taken in conjunction with the accompanying drawings in which:

FIG. 1 is a schematic block diagram of an image sensor according to one or more embodiments;

FIG. 2 illustrates an example of a pixel arrangement of a pixel array of an image sensor according to one or more embodiments;

FIGS. 3A, 3B, 3C, and 3D are cross-sectional views schematically showing a configuration of a pixel array of an image sensor according to one or more embodiments;

FIG. 4 is a plan view schematically showing a pixel arrangement of a sensor substrate in a pixel array of an image sensor according to one or more embodiments;

FIG. 5 is a plan view schematically showing an area arrangement of a nano optical lens array in a pixel array of an image sensor according to one or more embodiments;

FIG. 6 is a plan view showing a pixel arrangement of an image sensor according to a comparative example;

FIGS. 7A, 7B, 7C, and 7D are conceptual diagrams showing an occurrence of a phase difference depending on a color sampled from each unit pixel during image processing by an image sensor according to a comparative example;

FIG. 8 shows an example of an image processing process performed in an image sensor according to one or more embodiments;

FIGS. 9A, 9B, and 9C show examples of image formats illustrated in FIG. 8;

FIG. 10 is a cross-sectional view schematically showing a configuration of a pixel array of an image sensor according to one or more other embodiments;

FIG. 11 is a cross-sectional view schematically showing a configuration of a pixel array of an image sensor according to one or more other embodiments;

FIG. 12 is a plan view showing a color filter arrangement of a color filter array in the pixel array of the image sensor of FIG. 11;

FIG. 13 is a plan view schematically showing a pixel arrangement of a pixel array of an image sensor according to one or more other embodiments;

FIG. 14 is a plan view schematically showing a pixel arrangement of a pixel array of an image sensor according to one or more other embodiments;

FIG. 15 is a plan view schematically showing a pixel arrangement of a pixel array of an image sensor according to one or more other embodiments;

FIG. 16 is a plan view schematically showing a pixel arrangement of a pixel array of an image sensor according to one or more other embodiments;

FIG. 17 is a plan view schematically showing a pixel arrangement of a pixel array of an image sensor according to one or more other embodiments;

FIG. 18 is a plan view schematically showing a pixel arrangement of a pixel array of an image sensor according to one or more other embodiments;

FIG. 19 is a plan view schematically showing a pixel arrangement of a pixel array of an image sensor according to one or more other embodiments;

FIG. 20 is a plan view schematically showing a pixel arrangement of a pixel array of an image sensor according to one or more other embodiments;

FIG. 21 is a plan view schematically showing a pixel arrangement of a pixel array of an image sensor according to one or more other embodiments;

FIG. 22 is a perspective view schematically showing a configuration of a pixel array of an image sensor according to one or more other embodiments;

FIGS. 23A and 23B are cross-sectional views schematically showing the configuration of the pixel array of the image sensor of FIG. 22;

FIG. 24 is a plan view schematically showing a pixel arrangement of the pixel array of the image sensor of FIG. 22;

FIG. 25 is a plan view schematically showing a pixel arrangement of a pixel array of an image sensor according to one or more other embodiments;

FIG. 26 is a plan view schematically showing a pixel arrangement of a pixel array of an image sensor according to one or more other embodiments;

FIG. 27 is a plan view schematically showing a pixel arrangement of a pixel array of an image sensor according to one or more other embodiments;

FIG. 28 is a plan view schematically showing a pixel arrangement of a pixel array of an image sensor according to one or more other embodiments;

FIG. 29 is a plan view schematically showing a pixel arrangement of a pixel array of an image sensor according to one or more other embodiments;

FIG. 30 is a block diagram schematically showing a configuration of an electronic apparatus including an image sensor according to one or more embodiments;

FIG. 31 is a block diagram schematically showing a camera module of the electronic apparatus of FIG. 30;

FIG. 32 is a block diagram of an electronic apparatus including a multi- camera module; and

FIG. 33 is a detailed block diagram of one camera module of the electronic apparatus of FIG. 32.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects.

Hereinafter, embodiments are described in detail with reference to the accompanying drawings. Furthermore, as embodiments described below are examples, other modifications may be produced from the embodiments Sizes of components in the drawings may be exaggerated for convenience of explanation, and clarity.

When a constituent element is disposed “above” or “on” to another constituent element, the constituent element may include not only an element directly contacting and disposed on the other constituent element, but also an element disposed above the other constituent element in a non-contact manner.

Terms such as “first” and “second” are used herein merely to describe a variety of constituent elements, but the constituent elements are not limited by the terms. Such terms are used only for the purpose of distinguishing one constituent element from another constituent element.

As used herein, the singular forms “a,” “an,” and “the” are intended to include the plural forms as well, unless the context clearly indicates otherwise. It will be further understood that the terms “comprises” and/or “comprising” used herein specify the presence of stated features or elements, but do not preclude the presence or addition of one or more other features or elements.

Furthermore, terms such as “. . . portion,” “. . . unit,” “. . . module,” and “. . . block” stated in the disclosure may signify a unit to process at least one function or operation and the unit may be embodied by hardware, software, or a combination of hardware and software.

The use of the terms “a,” “an,” “the,” and similar referents in the context of describing the disclosure is to be construed to cover both the singular and the plural.

The steps of all methods described herein can be performed in any suitable order unless otherwise indicated herein or otherwise clearly contradicted by context. Furthermore, the use of any and all examples, or language (e.g., “such as”) provided herein, is intended merely to better illuminate the disclosure and does not pose a limitation on the scope of the disclosure unless otherwise claimed.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

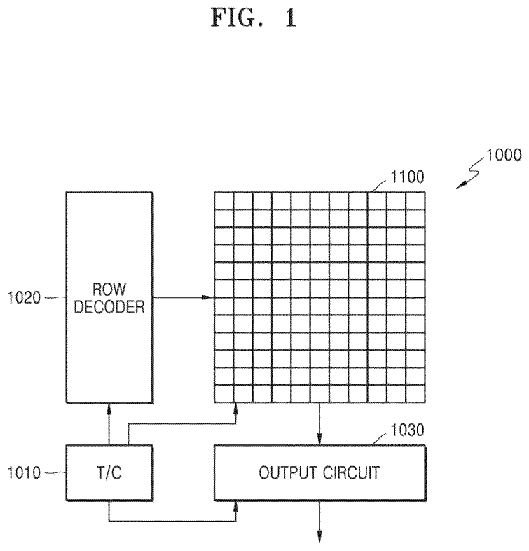

FIG. 1 is a schematic block diagram of an image sensor 1000 according to one or more embodiments. Referring to FIG. 1, the image sensor 1000 may include a pixel array 1100, a timing controller 1010, a row decoder 1020, and an output circuit 1030. The image sensor 1000 may be a charge-coupled device (CCD) image sensor or a complementary metal oxide semiconductor (CMOS) image sensor.

The pixel array 1100 may include pixels arranged in two dimensions along a plurality of rows and columns. The row decoder 1020 selects one of the rows of the pixel array 1100 in response to a row address signal output from the timing controller 1010. The output circuit 1030 outputs a light detection signal in units of columns from a plurality of pixels arranged along the selected row. To this end, the output circuit 1030 may include a column decoder and an analog-digital converter (ADC). For example, the output circuit 1030 may include a plurality of ADCs arranged for each column between the column decoder and the pixel array 1100 or one ADC arranged at an output end of the column decoder. The timing controller 1010, the row decoder 1020, and the output circuit 1030 may be implemented in one chip or separate chips. A processor to process an image signal output by the output circuit 1030 may be implemented in one chip with the timing controller 1010, the row decoder 1020, and the output circuit 1030.

The pixel array 1100 may include a plurality of pixels that detect light of different wavelengths. The arrangement of the pixels may be implemented in various methods.

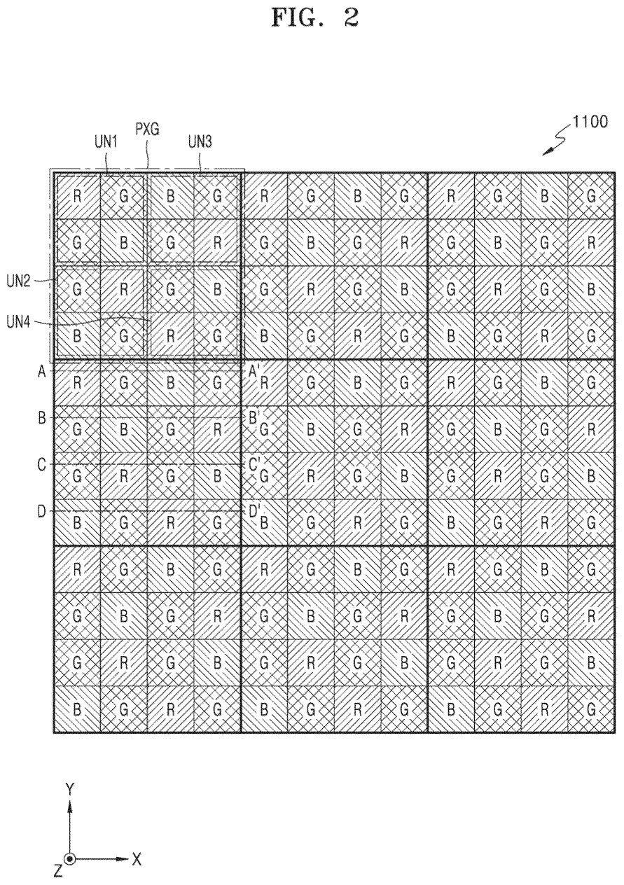

FIG. 2 is a plan view showing an example of a pixel arrangement of the pixel array 1100 of the image sensor 1000.

The pixel array 1100 may include a plurality of unit pixel groups PXG repeatedly arranged in two dimensions in a first direction (X direction) and a second direction (Y direction). Each unit pixel group PXG may include a first unit UN1, a second unit UN2, a third unit UN3, and a fourth unit UN4. In one or more embodiments, in the unit pixel group PXG, pieces of information with respect to red light, green light, and blue light, each having the same space information, may be obtained from the first unit UN1, and similarly, pieces of information about red light, green light, and blue light, each having the same space information, may be obtained from each of the second unit UN2, the third unit UN3, and the fourth unit UN4. Accordingly, demosaicing that is generally performed during image processing may be omitted. This is described again with the structure of a nano optical lens array 130 provided in the pixel array 1100.

The first unit UN1 includes a red pixel R, two green pixels G, and a blue pixel B arranged in a 2×2 format in the first direction (X direction) and the second direction (Y direction), in which the two green pixels G are adjacent to each other in one diagonal direction. The red pixel R and the blue pixel B are arranged to be adjacent to each other in another diagonal direction. As illustrated, the red pixel R and the green pixel G may be arranged in the first row of the first unit UN1 in the first direction (X direction), and the green pixel G and the blue pixel B may be arranged in the second row of the first unit UN1 in the first direction (X direction).

The second unit UN2 includes a red pixel R, two green pixels G, and a blue pixel B, and the arrangement of the second unit UN2 corresponds to the shape of the first unit UN1 rotated by 90 degrees with a third direction (Z direction) normal to the surface of the pixel array 1100 as an axis of rotation. For example, the green pixel G and the red pixel R are arranged in the first row of the second unit UN2 in the first direction (X direction), and the blue pixel B and the green pixel G are arranged in the second row of the second unit UN2 in the first direction (X direction).

The third unit UN3 also includes a red pixel R, two green pixels G, and a blue pixel B, and the arrangement of the third unit UN3 corresponds to the shape of the first unit UN1 rotated by 180 degrees with the third direction (Z direction) as an axis of rotation. For example, the blue pixel B and the green pixel G are arranged in the first row of the third unit UN3 in the first direction (X direction), and the green pixel G and the red pixel R are arranged in the second row of the third unit UN3 in the first direction (X direction).

The fourth unit UN4 includes a red pixel R, two green pixels G, and a blue pixel B, and the arrangement of the fourth unit UN4 corresponds to the shape of the first unit UN1 rotated by 270 degrees with the third direction (Z direction) as an axis of rotation. For example, the green pixel G and the blue pixel B are arranged in the first row of the fourth unit UN4 in the first direction (X direction), and the red pixel R and the green pixel G are arranged in the second row of the fourth unit UN4 in the first direction (X direction).

In one or more embodiments, each of the first unit UN1, the second unit UN2, the third unit UN3, and the fourth unit UN4 is similar to a basic unit constituting the pixel arrangement of a general Bayer pattern. In one or more embodiments, there is a difference from the general Bayer pattern in that the basic unit and configurations obtained by rotating the basic unit respectively by 90 degrees, 180 degrees, and 270 degrees are combined to constitute the unit pixel group PXG.

The first unit UN1, the second unit UN2, the third unit UN3, and the fourth unit UN4 included in the unit pixel group PXG are arranged in a 2×2 format in the first direction (X direction) and the second direction (Y direction), wherein the arrangement order is not limited to the illustrated order. For example, although FIG. 2 illustrates that the first unit UN1 and the third unit UN3 are arranged in the first row of the 2×2 format, and that the second unit UN2 and the fourth unit UN4 are arranged in the second row thereof, the units may be arranged in a different order.

The pixel arrangement of FIG. 2 may be applied to an arrangement of light-sensing cells in a sensor substrate 110 of the pixel array 1100. Furthermore, as areas of a nano optical lens array or a color filter array to be provided in the pixel array 1100 are determined in order to correspond to the colors represented by the pixel arrangement, the pixel arrangement of FIG. 2 may be interpreted as a color arrangement of the pixel array 1100.

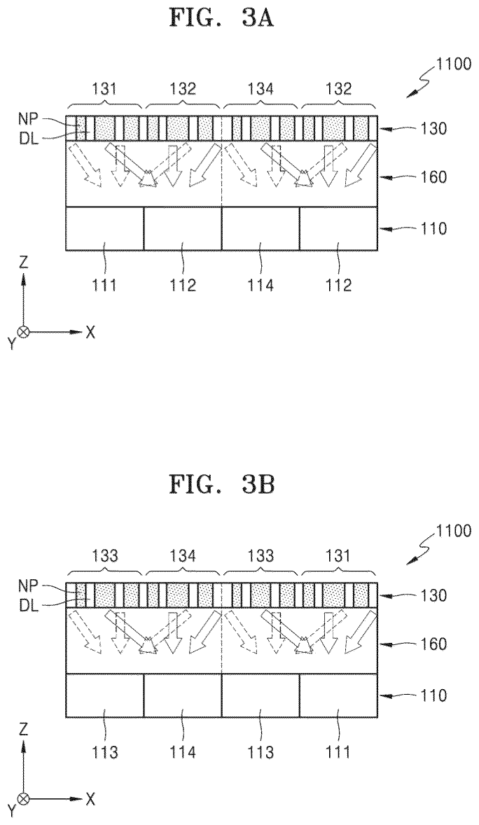

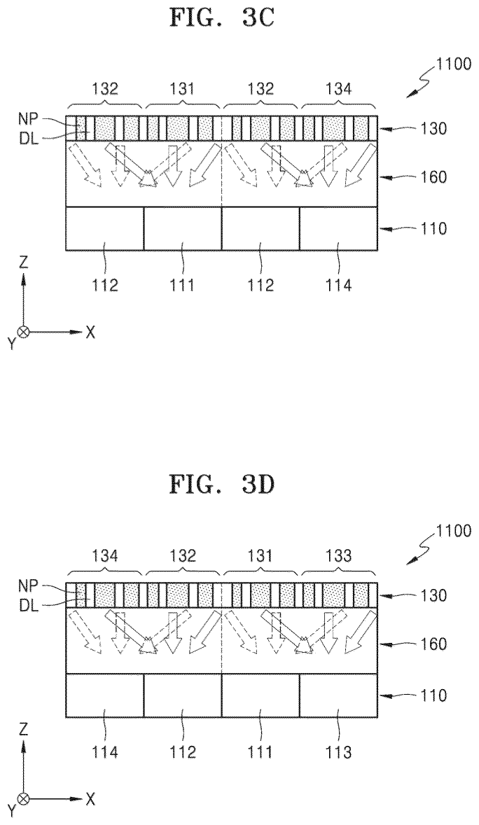

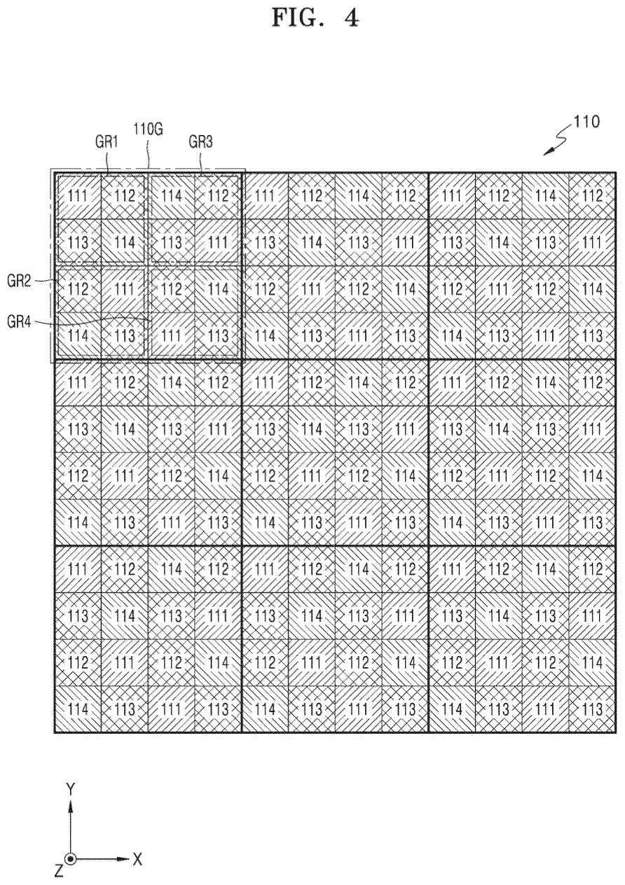

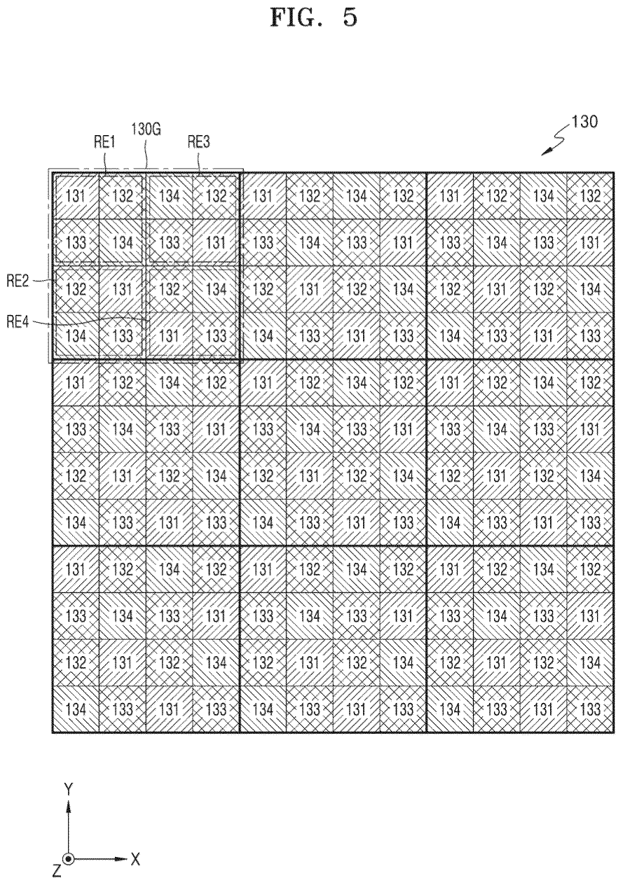

FIGS. 3A to 3D are cross-sectional views schematically showing a configuration of the pixel array 1100 of the image sensor 1000 of FIG. 1, respectively taken along line A-A′, line B-B′, line C-C′, and line D-D′ of FIG. 2. FIG. 4 is a plan view schematically showing a pixel arrangement of a sensor substrate 110 of the pixel array 1100 of the image sensor 1000 of FIG. 1, and FIG. 5 is a plan view schematically showing an area arrangement of a nano optical lens array 130 in the pixel array 1100 of the image sensor 1000 of FIG. 1.

Referring to FIGS. 3A to 3D, the pixel array 1100 may include the sensor substrate 110 including a plurality of light-sensing cells for sensing light and an optical element that focuses light onto each of the light-sensing cells of the sensor substrate 110. The optical element may include the nano optical lens array 130. A spacer layer 160 may be arranged between the nano optical lens array 130 and the sensor substrate 110.

The light-sensing cells in the sensor substrate 110 may be referred to as a first pixel 111, a second pixel 112, a third pixel 113, and a fourth pixel 114 according to the color of incident light. The first pixel 111, the second pixel 112, the third pixel 113, and the fourth pixel 114 may sense red light, green light, green light, and blue light, respectively, and may be substantially the same as the red pixel R, the green pixel G, the green pixel G, and the blue pixel B, described with reference to FIG. 2, respectively. For example, the sensor substrate 110, as illustrated in FIG. 4, may include a unit pixel group 110G that is substantially the same as the unit pixel group PXG described with reference to FIG. 2, and the unit pixel group 110G may include a first unit GR1, a second unit GR2, a third unit GR3, and a fourth unit GR4, which are substantially the same as the first unit UN1, the second unit UN2, the third unit UN3, and the fourth unit UN4 of FIG. 2, respectively.

In the following descriptions, the expressions of the first pixel 111 and the red pixel, the second pixel 112 and the green pixel, the third pixel 113 and the green pixel, and the fourth pixel 114 and the blue pixel may be interchangeably used.

An isolation layer that electrically isolates between the first to fourth pixels 111, 112, 113, and 114 may be formed between the first to fourth pixels 111, 112, 113, and 114 adjacent to each other. Furthermore, all or some of the first to fourth pixels 111, 112, 113, and 114 may be sectioned into a form that includes a plurality of light-sensing cells, for example, four light-sensing cells. As such, when each of the first to fourth pixels 111, 112, 113, and 114 is sectioned into a plurality of light-sensing cells, signals from the light-sensing cells may be used as autofocus signals, or for a binning mode operation to increase sensitivity in a low light environment.

The spacer layer 160 is arranged between the sensor substrate 110 and the nano optical lens array 130 to maintain constant a gap between the sensor substrate 110 and the nano optical lens array 130. The spacer layer 160 may include a transparent material with respect to visible light, for example, poly methylmethacrylate (P MMA), silanol-based glass (siloxane-based spin-on-glass (SOG)), silicon oxide (SiO₂), silicon nitride (Si₃N₄), aluminum oxide (Al₂O₃), etc., which is a dielectric material having a refractive index less than a refractive index of a nanostructure NP described below and a relatively low absorption rate in a visible light band.

The nano optical lens array 130 may be provided on the spacer layer 160. An etch stop layer may be further provided between the spacer layer 160 and the nano optical lens array 130 to protect the spacer layer 160 in a process of forming the nano optical lens array 130.

The nano optical lens array 130 may include a plurality of first areas 131 corresponding to the first pixels 111, a plurality of second areas 132 corresponding to the second pixels 112, a plurality of third areas 133 corresponding to the third pixels 113, and a plurality of fourth areas 134 corresponding to the fourth pixels 114. The first area 131 may be arranged to face the first pixel 111 in the third direction (Z direction), the second area 132 may be arranged to face the second pixel 112 in the third direction, the third area 133 may be arranged to face the third pixel 113 in the third direction, and the fourth area 134 may be arranged to face the fourth pixel 114 in the third direction.

For example, the first to fourth areas 131, 132, 133, and 134 illustrated in FIG. 5 may be two-dimensionally arranged in the same manner as the first to fourth pixels 111, 112, 113, and 114 illustrated in FIG. 4. For example, the nano optical lens array 130 may include a plurality of nano optical lens groups 130G repeatedly arranged in the first direction (X direction) and the second direction (Y direction), and each of the nano optical lens groups 130G may include a first unit structure RE1, a second unit structure RE2, a third unit structure RE3, and a fourth unit structure RE4 arranged in a 2×2 format in the first direction (X direction) and the second direction (Y direction). The nano optical lens groups 130G faces the unit pixel group 110G of the sensor substrate 110, and the first unit structure RE1, the second unit structure RE2, the third unit structure RE3, and the fourth unit structure RE4 face the first unit GR 1, the second unit GR 2, the third unit GR 3, and the fourth unit GR 4 of the sensor substrate 110, respectively. For example, the second unit structure RE2, the third unit structure RE3, and the fourth unit structure RE4 respectively correspond to the shapes of the first unit structure RE1 rotated by 90 degrees, 180 degrees, and 270 degrees with the third direction (Z direction) as an axis of rotation.

According to one or more embodiments, the nano optical lens array 130 may be configured to separate color of incident light. For example, the nano optical lens array 130 may separate the incident light into light of a first wavelength band (e.g., red light), light of a second wavelength band (e.g., green light), and light of a third wavelength band (e.g., blue light) to travel along different paths. Furthermore, the nano optical lens array 130 may be configured to perform a function of a lens for focusing the light of a first wavelength band, the light of a second wavelength band, and the light of a third wavelength band, which are color-separated, onto pixels. For example, the nano optical lens array 130 may be configured to focus, from the incident light, green light onto the second pixel 112 and the third pixel 113, red light onto the first pixel 111, and blue light onto the fourth pixel 114.

Furthermore, in the nano optical lens array 130 according to one or more embodiments, color separation and focusing may occur independently for each unit structure, for example, in each of the first unit structure RE1, the second unit structure RE2, the third unit structure RE3, and the fourth unit structure RE4. For example, light incident on any one of the first unit structure RE1, the second unit structure RE2, the third unit structure RE3, and the fourth unit structure RE4 is color-separated only within the corresponding unit structure and focused onto a pixel corresponding to the unit structure, and each unit structure does not affect color separation and focusing in other unit structures adjacent thereto. For example, of the light incident on one first unit structure RE1, green light is focused only onto the second pixel 112 and the third pixel 113 corresponding to the second area 132 and the third area 133 of the first unit structure RE1, and is not focused onto the second pixel 112 and the third pixel 113 corresponding to each of the second unit structure RE2, the third unit structure RE3, and the fourth unit structure RE4 adjacent thereto. Similarly, of the light incident on the first unit structure RE1, blue light is focused only onto the fourth pixel 114 corresponding to the fourth area 134 of the first unit structure RE1, and is not focused onto the fourth pixel 114 corresponding to each of the second unit structure RE2, the third unit structure RE3, and the fourth unit structure RE 4 adjacent thereto. Of the light incident on the first unit structure RE1, red light is focused only onto the first pixel 111 corresponding to the first area 131 of the first unit structure RE1, and is not focused onto the first pixel 111 corresponding to each of the second unit structure RE2, the third unit structure RE3, and the fourth unit structure RE4 adjacent thereto. As such, the second unit structure RE2, the third unit structure RE3, and the fourth unit structure RE4, adjacent to the first unit structure RE1, are optically separated from one another so that no exchange of light or energy occurs between the different unit structures. As such, the light that is color-separated and focused within one unit structure includes space information of only light incident on the unit structure, and does not include space information of light incident on other adjacent unit structures. The outputs of pixels of a basic unit corresponding to one unit structure of the nano optical lens array 130 may all have the same space information regardless of colors. For example, in a basic unit corresponding to one unit structure, green light signals output from the first pixel 111 and the fourth pixel 114, a blue light signal output from the second pixel 112, and a red light signal output from the third pixel 113 may all have the same space information. In this case, green light signals, blue light signals, and blue light signals output from all the pixels of the pixel array 1100 or the image sensor 1000 may all have seamless space information about the entire area of the image sensor 1000 or the pixel array 1100. Accordingly, an operation such as demosaicing or color filter array interpolation for filling empty space information between the same color pixels in the existing image sensor may be omitted in an image processing process of generating an image using the signals output from the image sensor 1000 according to one or more embodiments. Accordingly, the amount of operations and power consumption of an image signal processing processor of an apparatus including the image sensor 1000 or a processor of the image sensor 1000 may be reduced.

The nano optical lens array 130 may include a plurality of nanostructures NP periodically arranged according to a certain rule. One or more nanostructures NP may be arranged in each of the first areas 131, the second area 132, the third areas 133, and the fourth areas 134, which are provided in the nano optical lens array 130. In the plan view of FIG. 5, the illustration of the nanostructures NP is omitted, and the arrangements of the nanostructures NP illustrated in FIGS. 3A to 3D are examples for convenience.

The nano optical lens array 130 may further include a dielectric layer DL filled between the nanostructures NP separated from each other. In order for the nano optical lens array 130 to perform the functions described above, the nanostructures NP of the nano optical lens array 130 may be configured in various ways. For example, the nanostructures NP may be arranged to change the phase of light passing through the nano optical lens array 130 to differ depending on the location in the nano optical lens array 130. The phase profile of transmitted light implemented by the nano optical lens array 130 may be determined according to a cross-sectional size (e.g., width or diameter), a cross-sectional shape, and a height of each of the nanostructures NP, and an interval, an arrangement cycle (or pitch), and an arrangement form of the nanostructures NP. Furthermore, the behavior of the light having passed through the nano optical lens array 130 may be determined depending on the phase profile of the transmitted light.

The nanostructures NP may each have a size less than the wavelength of visible light. The nanostructures NP may each have, for example, a size less than the wavelength of blue light. For example, the cross-sectional width (or diameter) of each of the nanostructures NP may be less than 400 nm, 300 nm, or 200 nm and greater than about 80 nm. The height, that is, the length in the third direction (Z direction) of each of the nanostructures NP, may be about 500 nm to about 1500 nm, and the height may be greater than the width in a cross-section of each of the nanostructures NP.

The nanostructures NP may each include a material having a relatively high refractive index and a relatively low absorption rate in the visible light band, compared with the surrounding materials. For example, the nanostructures NP may each include c-Si, p-Si, a-Si, and III-V compound semiconductors (gallium phosphide (GaP), gallium nitride (GaN), gallium arsenide (GaAs), etc.), silicon carbide (SiC), titanium oxide (TiO₂), SiN₃, zinc sulfide (ZnS), zinc selenide (ZnSe), Si₃N₄, and/or a combination thereof. The nanostructures NP may each be surrounded by the dielectric layer DL having a relatively low refractive index and a relatively low absorption rate in the visible light band, compared with the nanostructures NP. For example, the dielectric layer DL may include PMMA, silanol-based glass SOG, SiO₂, Si₃N₄, Al₂O₃, air, etc.

The refractive index of each of the nanostructures NP may be greater than or equal to about 2.0 with respect to light having a wavelength of about 630 nm, and the refractive index of the dielectric layer DL may be greater than or equal to about 1.0 and less than 2.0 with respect to the light of a wavelength of about 630 nm. Furthermore, a difference in refractive index between the nanostructures NP and the dielectric layer DL may be greater than or equal to about 0.5. The nanostructures NP having a refractive index difference from the surrounding materials may change the phase of light passing through the nanostructures NP. Such changes may occur due to a phase delay occurring by shape dimensions of a sub-wavelength of the nanostructures NP, and a degree of phase delay may be determined by specific shape dimensions, arrangement forms, etc. of the nanostructures NP.

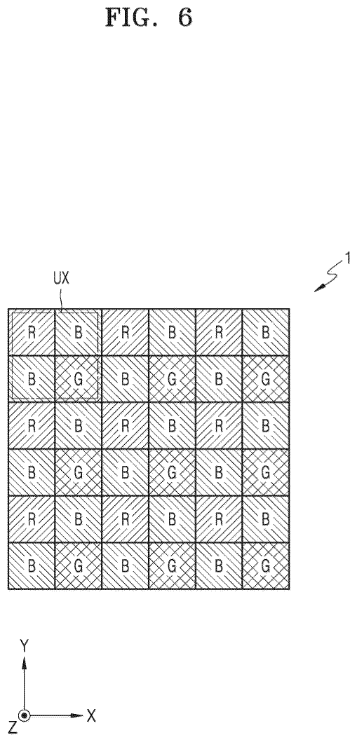

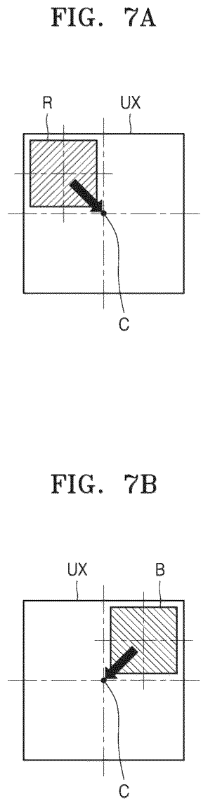

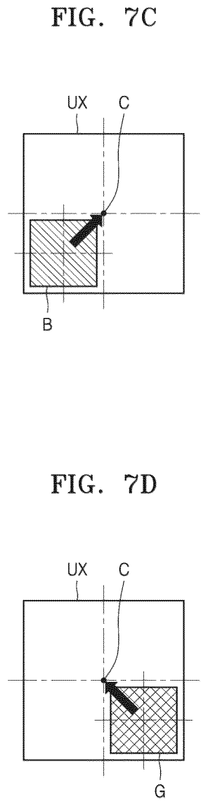

FIG. 6 is a plan view showing a pixel arrangement of a pixel array 1 of an image sensor according to a related example. FIGS. 7A to 7D are conceptual diagrams showing an occurrence of a phase difference depending on a color sampled from each unit pixel during image processing by an image sensor according to a related example.

Referring to FIG. 6, the pixel array 1 may include a plurality of unit pixels UX that are repeatedly arranged, and a red pixel R, two blue pixels B, and a green pixel G are arranged in each of the unit pixels UX in a 2×2 format in the first direction (X direction) and the second direction (Y direction). The two blue pixels B are adjacent to each other in one diagonal direction, and the red pixel R and the green pixel G are adjacent to each other in another diagonal direction.

When an RGB image is created from signals detected by the unit pixels UX, a process of sampling only a corresponding color at each position of the red pixel R, the blue pixel B, and the green pixel G within each unit pixel UX is performed.

Referring to FIG. 7A, the center of the sampled red pixel R is spaced apart from the center C of the unit pixel UX in the upper left direction, and referring to FIG. 7D, the center of the sampled green pixel G is apart from the center C of the unit pixel UX in the lower right direction. Such separation is represented as a phase difference (phase shift).

Referring to FIGS. 7B and 7C, the two sampled blue pixels B are spaced apart from the center C of the unit pixel UX in the upper right and lower left directions, respectively. The separation distance is ¼ of a diagonal length of the unit pixel UX. To create an RGB image, the signals of the two blue pixels B are averaged, and thus, the center thereof matches the center C of the unit pixel UX, and the phase difference disappears.

As such, when an RGB image is created by overlapping a red signal value and a green signal value, each having a phase difference, with a blue signal value, red and green are deviated from an object's boundary with respect to the center of blue so that a false color of yellow may be generated. As the generation of a false color is due to the phase difference, image interpolation processing for phase correction is performed, and in this case, resolving power of the corresponding channel is reduced.

Unlike the repeated arrangement of the unit pixels UX in the same arrangement form in the related example, in the pixel array 1100 of the image sensor according to the embodiment described above, the second unit UN2, the third unit UN3, and the fourth unit UN4 respectively correspond to the shapes of the first unit UN1 rotated by 90 degrees, 180 degrees, and 270 degrees, and the unit pixel group PXG that is a combination of the rotated shapes is repeatedly arranged.

By this method, aliasing due to down-sampling generated when creating an RGB image may be reduced.

Furthermore, unlike the color arrangement of the unit pixels UX applied to the related example, the pixel array 1100 of the image sensor according to the embodiment has a pixel arrangement of the two green pixels G located in a diagonal direction in each of the first unit UN1, the second unit UN2, the third unit UN3, and the fourth unit UN4 constituting the unit pixel group PXG.

According to the arrangement, green becomes a color in which no phase difference occurs, and red and blue each have a phase difference in different directions compared with the green. Green plays an important role as a signal forming luminance in image quality and is a signal that contributes much to resolving power. Preserving a green signal may be needed. For example, when an image is processed in a YUV (YCbCr) domain, jpeg and video use YUV 422 or YUV 420, and an ultraviolet (UV) signal is band-limited. Thus, in this process, a phase difference between a red signal and a blue signal may be absorbed.

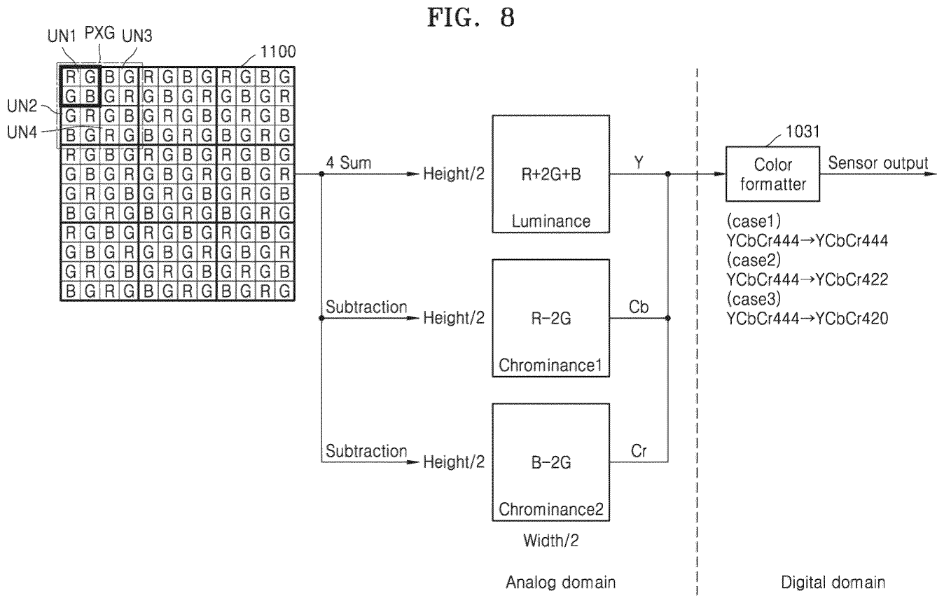

FIG. 8 shows an example of an image processing process performed in an image sensor according to one or more embodiments.

Referring to FIG. 8, image data of various formats may be generated by performing analog binning for each unit pixel pattern in the pixel array 1100. For example, in FIG. 8, the first unit UN1 within one unit pixel group PXG is marked with a bold square. First, in the first unit UN1, one luminance signal Y may be generated by summing (adding) all of an output of the red pixel R (e.g., the first pixel 111), outputs of the two green pixels G (e.g., the second pixel 112 and the third pixel 113), and an output of the blue pixel B (e.g., the fourth pixel 114. Furthermore, within the first unit UN1, a first color signal Cb may be generated by subtracting the outputs of the two green pixels from the output of the red pixel, and a second color signal Cr may be generated by subtracting the outputs of the two green pixels from the output of the blue pixel.

In FIG. 8, Height and Width respectively are the height and the width of one first unit UN1, and Height/2 and Width/2 in FIG. 8 respectively indicate the width and the height of each pixel. According to one or more embodiments, without performing demosaicing processing on the output of the red pixel, the outputs of the two green pixels, and the output of the blue pixel, the luminance signal Y, the first color signal Cb, and the second color signal Cr may be generated directly from the outputs of the pixels. For the first unit UN1 of one unit pixel group PXG, one luminance signal Y, one first color signal Cb, and one second color signal Cr may be generated. Each of the luminance signal Y, the first color signal Cb, and the second color signal Cr, which are generated as above, may include space information for one first unit UN1. The signals Y, Cb, and Cr may be generated for the second unit UN2, the third unit UN3, and the fourth unit UN4 in the unit pixel group PXG.

Then, the image sensor 1000 may convert the luminance signal Y, the first color signal Cb, and the second color signal Cr, which are analog signals, into digital signals, and generate image data in various digital formats. For example, upon a request of an external device including the image sensor 1000, the image sensor 1000 may selectively generate image data having any one of a plurality of different digital image formats, such as a YCbCr 444 format, a YCbCr 422 format, and a YCbCr 420 format, and output the generated image data to the outside. As another example, when an external device uses only one format, image data having only set format of the YCbCr 444 format, the YCbCr 422 format, and the YCbCr 420 format may be generated and output to the outside.

The image processing described with reference to FIG. 8 may be performed by, for example, the output circuit 1030 in the image sensor 1000. The output circuit 1030 may generate the luminance signal Y, the first color signal Cb, and the second color signal Cr, which are analog signals, and convert these signals into digital signals. Furthermore, the output circuit 1030 may include a color formatter 1031 configured to selectively generate image data in the YCbCr 444 format, the YCbCr 422 format, or the YCbCr 420 format, by using the luminance signal Y, the first color signal Cb, and the second color signal Cr, which are digitalized.

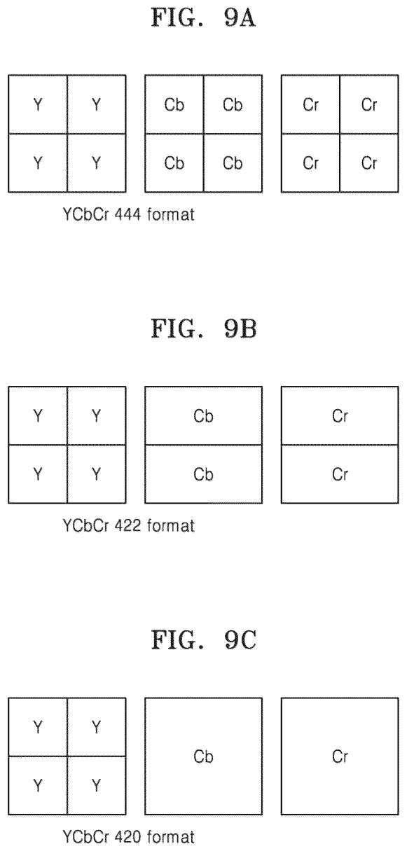

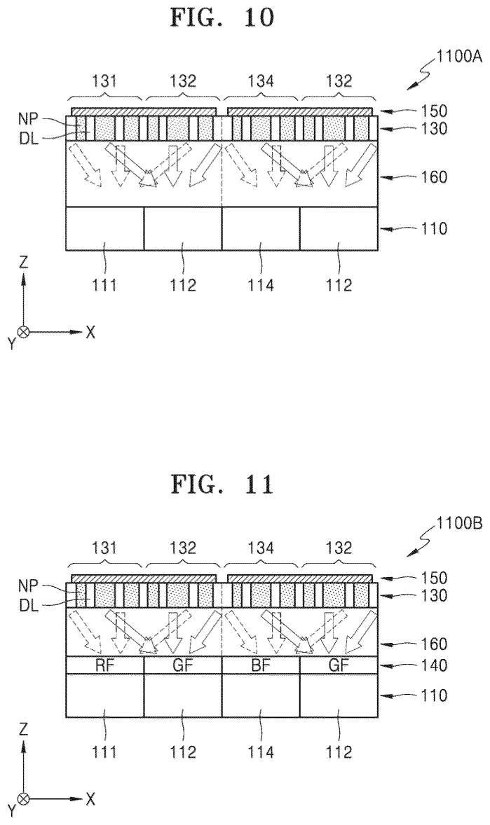

FIGS. 9A, 9B, and 9C show examples of the image formats illustrated in FIG. 8. Referring to FIG. 9A first, in the YCbCr 444 format, unit image data may include four luminance signals Y, four first color signals Cb, and four second color signals Cr. The four luminance signals Y, the four first color signals Cb, and the four second color signals Cr are obtained by combining the outputs of the first unit UN1, the second unit UN2, the third unit UN3, and the fourth unit UN4, which are four units adjacent to one another. When the image sensor 1000 provides image data in the YCbCr 444 format to an external electronic apparatus, the external electronic apparatus may additionally process the image data in the YCbCr 444 format to fit for purpose.

Referring to FIG. 9B, in the YCbCr 422 format, unit image data may include four luminance signals Y, two first color signals Cb, and two second color signals Cr. For the YCbCr 422 format, from the YCbCr 444 format illustrated in FIG. 9A, two first color signals Cb are obtained by averaging two of the four first color signals Cb, which are adjacent to each other in a horizontal direction. Furthermore, from the YCbCr 444 format, two second color signals Cr are obtained by averaging two of the four second color signals Cr, which are adjacent to each other in the horizontal direction. The YCbCr 422 format may be mainly used for, for example, still images adopting the joint photographic experts group (JPEG) standard.

Referring to FIG. 9C, in the YCbCr 420 format, unit image data may include the four luminance signals Y, one first color signal Cb, and one second color signal Cr. For the YCbCr 420 format, from the YCbCr 444 format illustrated in FIG. 9A, one first color signal Cb is obtained by averaging all of the four first color signals Cb, and one second color signal Cr is obtained by averaging all of the four second color signals Cr. The YCbCr 420 format may be mainly used for, for example, videos adopting the moving picture experts group (MPEG)-4 standard.

As described above, as the image sensor 1000 may perform image processing without demosaicing, the amount of operations for image processing may be reduced, an image processing speed may be improved, and power consumption of the image sensor 1000 may be reduced. Furthermore, as the image sensor 1000 outputs image data in a specific image format through the image processing as above, even in a processor of the external device including the image sensor 1000, the amount of operations may be reduced, and the operation speed of the external device may be improved. Furthermore, as the image processing, in which, with the pixel arrangement for preserving green signals, a combination of structures of the basic unit rotated variously is used as the unit pixel groups that are repeatedly arranged, the deterioration of resolving power or aliasing (false color) may be reduced or prevented.

FIG. 10 is a cross-sectional view schematically showing a configuration of a pixel array 1100A of an image sensor according to one or more other embodiments.

FIG. 10 is a cross-sectional view taken along the line A-A′ in FIG. 2. The pixel array 1100A differs from the pixel array 1100 illustrated in FIG. 3A in that the former further includes an optical diffuser 150 provided on the nano optical lens array 130.

The optical diffuser 150 may scatter incident light to be incident on the nano optical lens array 130. The optical diffuser 150, as illustrated, may be sectioned into units respectively corresponding to first to fourth unit structures (RE1, RE2, RE3, and RE4 of FIG. 5) constituting the nano optical lens array 130. As the directivity of incident light is removed by the optical diffuser 150, the light may be incident on the nano optical lens array 130. Furthermore, an optical separation between a plurality of unit structures (RE1, RE2, RE3, and RE4 of FIG. 5) of the nano optical lens array 130 may be made more certain by the optical diffuser 150. The light having passed through the optical diffuser 150 and incident on the nano optical lens array 130 may be color-separated by wavelength by the nano optical lens array 130 and focused onto each of the first to fourth pixels 111, 112, 113, and 114.

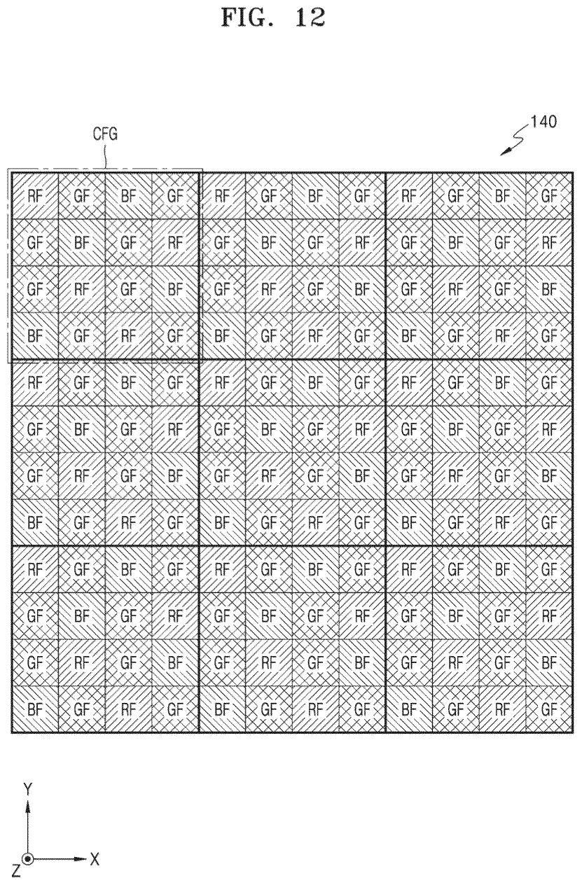

FIG. 11 is a cross-sectional view schematically showing a configuration of a pixel array 1100B of an image sensor according to one or more other embodiments, and FIG. 12 is a plan view showing a color filter arrangement of a color filter array 140 in the pixel array 1100B of the image sensor of FIG. 11.

The pixel array 1100B differs from the pixel array 1100A of FIG. 10 in that the former further includes the color filter array 140 arranged between the sensor substrate 110 and the nano optical lens array 130.

The color filter array 140 may include a plurality of color filter groups CFG that are repeatedly arranged in two dimensions. The color filter groups CFG may each include a plurality of red filters RF, a plurality of green filters GF, and a plurality of blue filters BF, and the arrangement thereof is the same as the color arrangement described with reference to FIG. 2.

The red filters RF, the green filters GF, and the blue filters BF each are filters that transmit only light of a corresponding color of the incident light. Color light that has been color-separated by the nano optical lens array 130 is incident on each of the color filters of the color filter array 140. Accordingly, the color purity of the color light incident on the sensor substrate 110 may be increased by the color filter array 140.

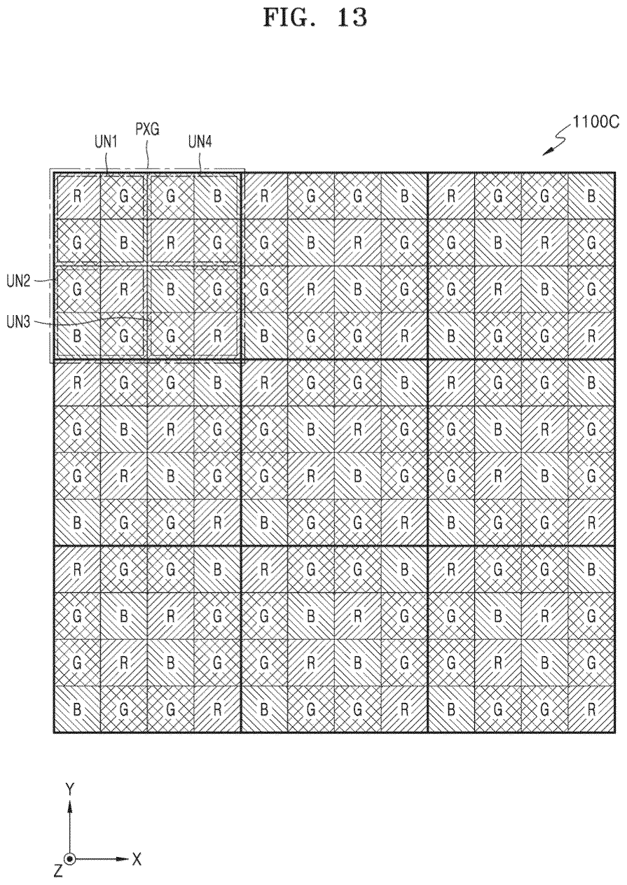

FIG. 13 is a plan view schematically showing a pixel arrangement of a pixel array 1100C of an image sensor according to one or more other embodiments.

The pixel array 1100C may include a plurality of unit pixel groups PXG that are repeatedly arranged, and may differ from the pixel array 1100 described with reference to FIG. 2 in the arrangement form of the first unit UN1, the second unit UN2, the third unit UN3, and the fourth unit UN4 within the unit pixel group PXG.

When the first unit UN1, the second unit UN2, the third unit UN3, and the fourth unit UN4 in the unit pixel group PXG are arranged in a 2×2 format, the first unit UN1 and the fourth unit UN4 may be sequentially arranged in the first row, and the second unit UN2 and the third unit UN3 may be sequentially arranged in the second row.

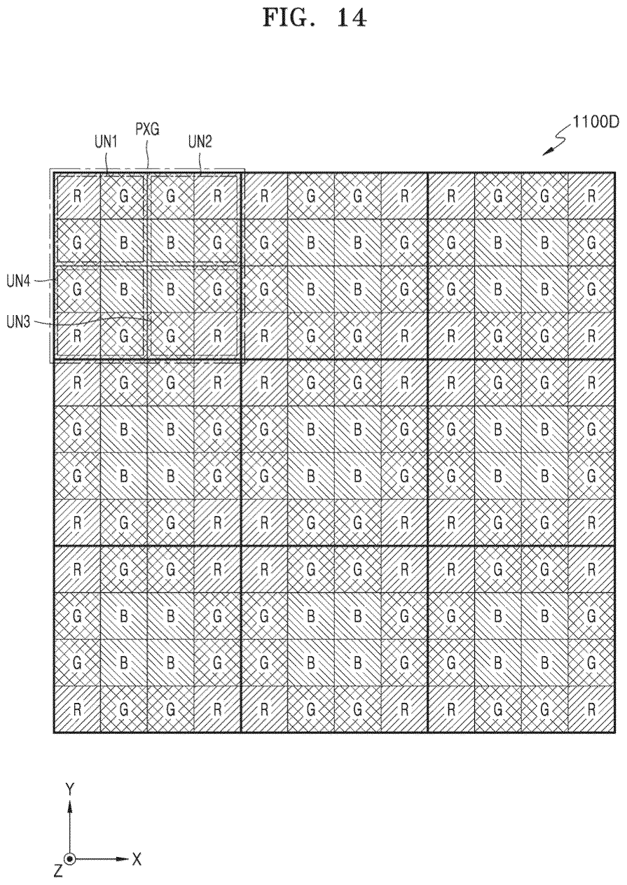

FIG. 14 is a plan view schematically showing a pixel arrangement of a pixel array 1100D of an image sensor according to one or more other embodiments.

The pixel array 1100D may include a plurality of unit pixel groups PXG that are repeatedly arranged, and may differ from the pixel array 1100 described with reference to FIG. 2 in the arrangement form of the first unit UN1, the second unit UN2, the third unit UN3, and the fourth unit UN4 in the unit pixel group PXG.

When the first unit UN1, the second unit UN2, the third unit UN3, and the fourth unit UN4 in the unit pixel group PXG are arranged in a 2×2 format, the first unit UN1 and the second unit UN2 may be sequentially arranged in the first row, and the fourth unit UN4 and the third unit UN3 may be sequentially arranged in the second row.

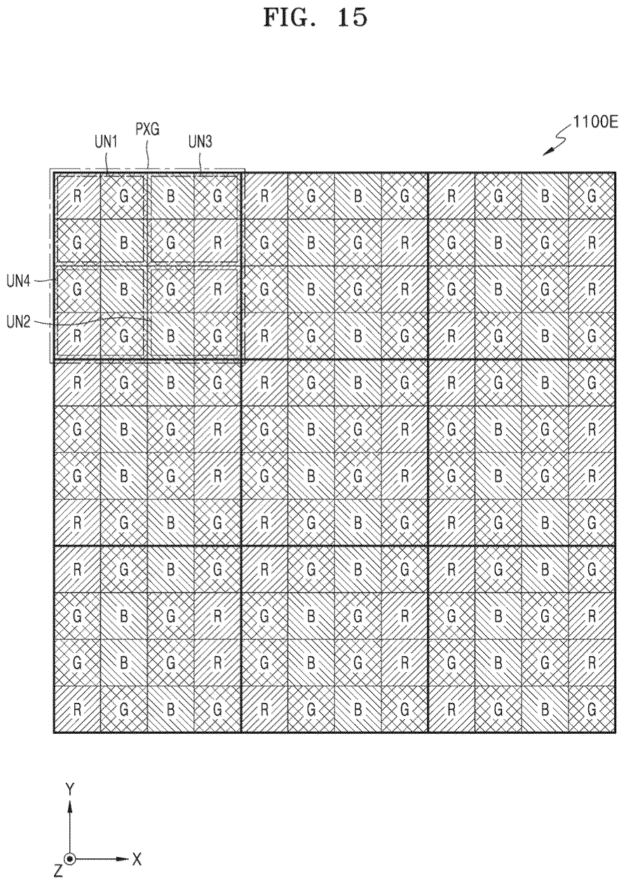

FIG. 15 is a plan view schematically showing a pixel arrangement of a pixel array 1100E of an image sensor according to one or more other embodiments.

The pixel array 1100E may include a plurality of unit pixel groups PXG that are repeatedly arranged, and may differ from the pixel array 1100 described with reference to FIG. 2 in the arrangement form of the first unit UN1, the second unit UN2, the third unit UN3, and the fourth unit UN4 in the unit pixel group PXG.

When the first unit UN1, the second unit UN2, the third unit UN3, and the fourth unit UN4 in the unit pixel group PXG are arranged in a 2×2 format, the first unit UN1 and the third unit UN3 may be sequentially arranged in the first row, and the fourth unit UN4 and the second unit UN2 may be sequentially arranged in the second row.

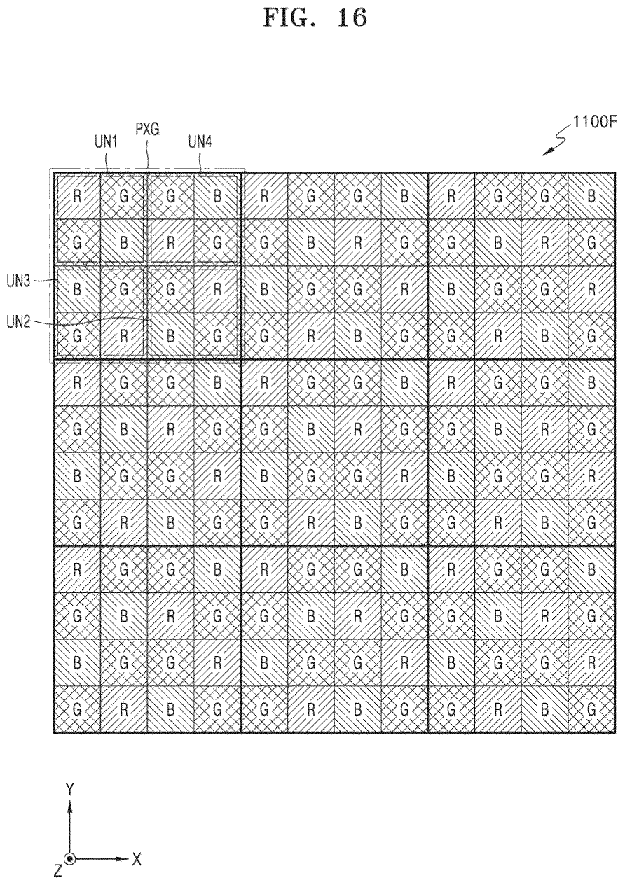

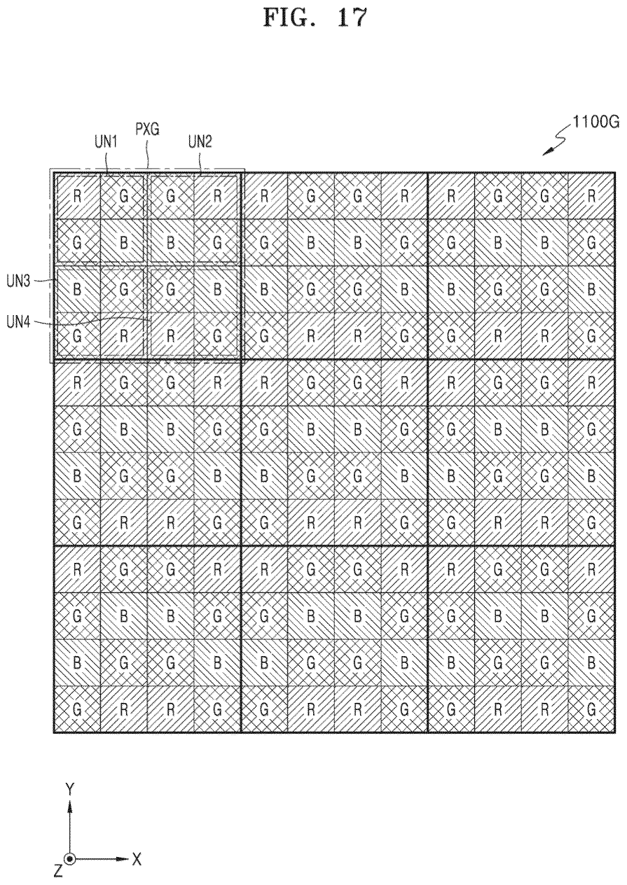

FIG. 16 is a plan view schematically showing a pixel arrangement of a pixel array 1100F of an image sensor according to one or more other embodiments.

The pixel array 1100F may include a plurality of unit pixel groups PXG that are repeatedly arranged, and may differ from the pixel array 1100 described with reference to FIG. 2 in the arrangement form of the first unit UN1, the second unit UN2, the third unit UN3, and the fourth unit UN4 in the unit pixel group PXG.

When the first unit UN1, the second unit UN2, the third unit UN3, and the fourth unit UN4 in the unit pixel group PXG are arranged in a 2×2 format, the first unit UN1 and the fourth unit UN4 may be sequentially arranged in the first row, and the third unit UN3 and the second unit UN2 may be sequentially arranged in the second row.

FIG. 17 is a plan view schematically showing a pixel arrangement of a pixel array 1100G of an image sensor according to one or more other embodiments.

The pixel array 1100G may include a plurality of unit pixel groups PXG that are repeatedly arranged, and may differ from the pixel array 1100 described with reference to FIG. 2 in the arrangement form of the first unit UN1, the second unit UN2, the third unit UN3, and the fourth unit UN4 in the unit pixel group PXG.

When the first unit UN1, the second unit UN2, the third unit UN3, and the fourth unit UN4 in the unit pixel group PXG are arranged in a 2×2 format, the first unit UN1 and the second unit UN2 may be sequentially arranged in the first row, and the third unit UN3 and the fourth unit UN4 may be sequentially arranged in the second row.

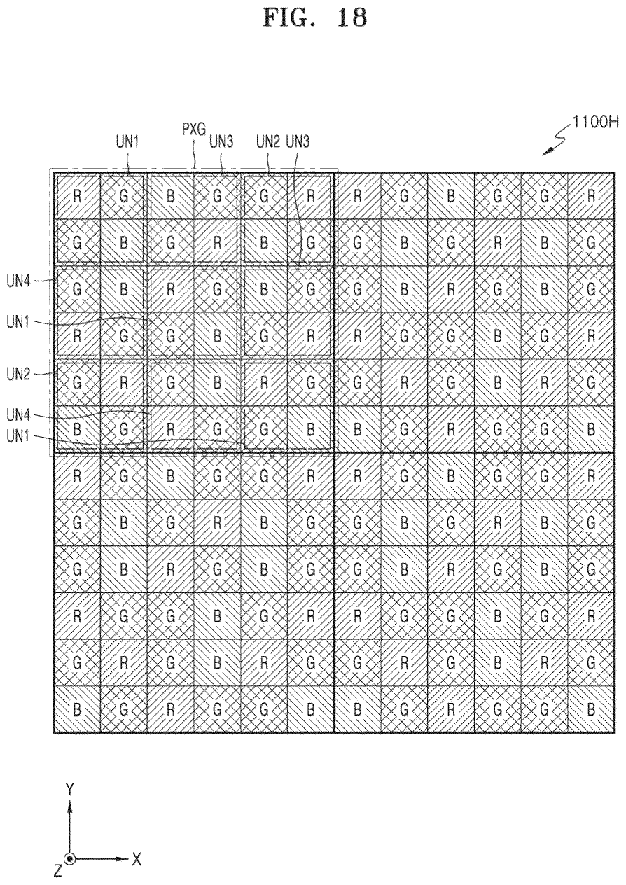

FIG. 18 is a plan view schematically showing a pixel arrangement of a pixel array 1100H of an image sensor according to one or more other embodiments.

The pixel array 1100H may include a plurality of unit pixel groups PXG that are repeatedly arranged, and nine units that are selected, with the possibility of duplication, from among the first unit UN1, the second unit UN2, the third unit UN3, and the fourth unit UN4 are arranged in a 3×3 format within the unit pixel group PXG. The nine units may include one or more of each of the first unit UN1, the second unit UN2, the third unit UN3, and the fourth unit UN4. As illustrated, the arrangement of the first row may be in an order of the first unit UN1, the third unit UN3, and the second unit UN2, the arrangement of the second row may be in an order of the fourth unit UN4, the first unit UN1, and the third unit UN3, and the arrangement of the third row may be in an order of the second unit UN2, the fourth unit UN4, and the first unit UN1.

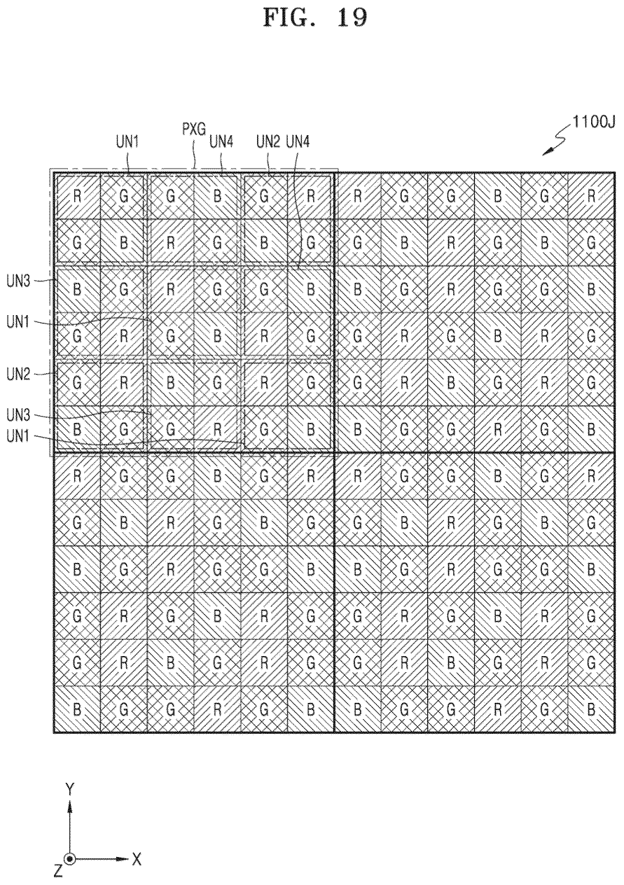

FIG. 19 is a plan view schematically showing a pixel arrangement of a pixel array 1100J of an image sensor according to one or more other embodiments.

The pixel array 1100J may include a plurality of unit pixel groups PXG based on a 3×3 format, which is similar to the pixel array 1100H of FIG. 18. The arrangement of the first row may be in an order of the first unit UN1, the fourth unit UN4, and the second unit UN2, the arrangement of the second row may be in an order of the third unit UN3, the first unit UN1, and the fourth unit UN4, and the arrangement of the third row may be in an order of the second unit UN2, the third unit UN3, and the first unit UN1.

The 3×3 arrangement is not limited to the form illustrated in FIGS. 18 and 19 and may be modified in various ways. For example, nine units are selected, with the possibility of duplication, from among the first unit UN1, the second unit UN2, the third unit UN3, and the fourth unit UN4, and thus, nine units may include one or more of each of the first unit UN1, the second unit UN2, the third unit UN3, and the fourth unit UN4. The nine units may be arranged such that units of a same type are not directly adjacent to each other in the first direction (X direction) and the second direction (Y direction). For example, two first units UN1 may be arranged adjacent to each other in a diagonal direction, but not in the first direction (X direction) and the second direction (Y direction). For example, identical units among the first unit UN1, the second unit UN2, the third unit UN3, and the fourth unit UN4 may be spaced apart from each other in the first direction (X direction) and the second direction (Y direction). However, embodiments are not limited thereto.

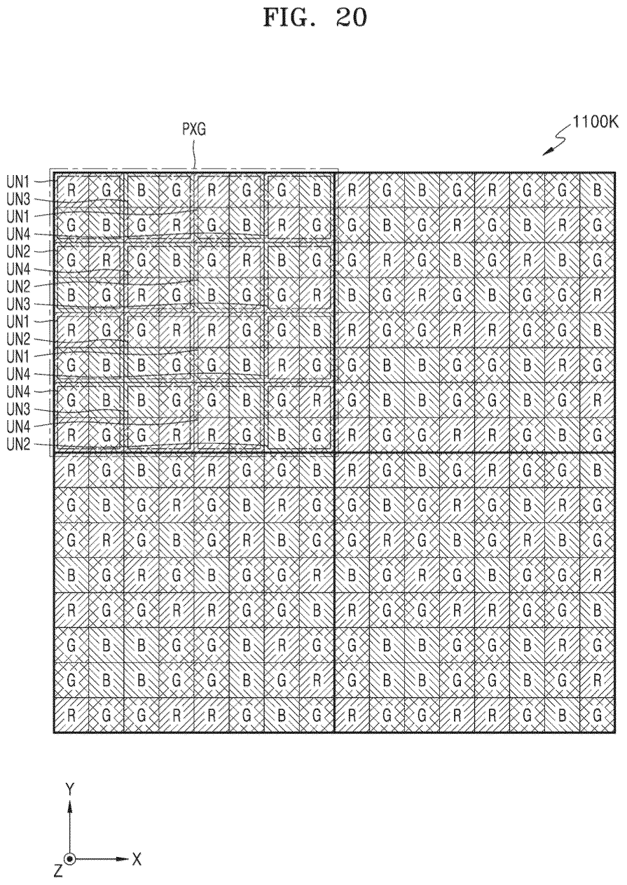

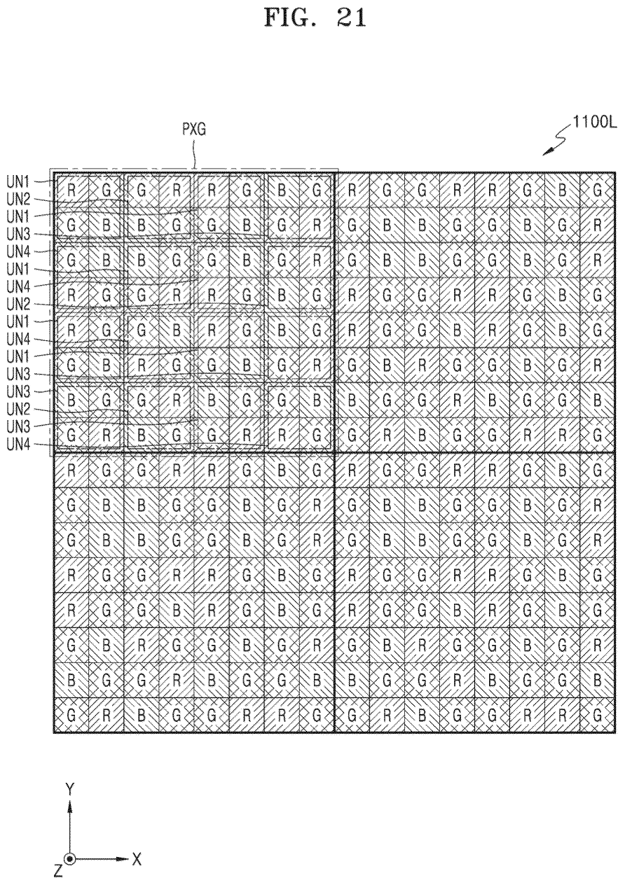

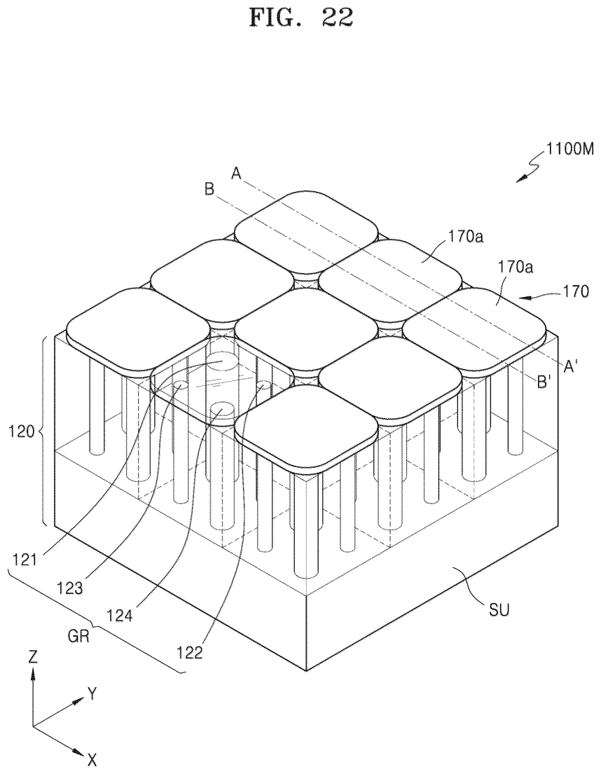

FIGS. 20 and 21 are plan views schematically showing the pixel arrangements of pixel arrays 1100K and 1100L of an image sensor according to one or more embodiments.

The pixel array 1100K of FIG. 20 and the pixel array 1100L of FIG. 21 may each include a plurality of unit pixel groups PXG that are repeatedly arranged, and sixteen units are arranged in a 4×4 format within the unit pixel groups PXG.

Sixteen units are selected, with the possibility of duplication, from among the first unit UN1, the second unit UN2, the third unit UN3, and the fourth unit UN4, and the sixteen units may include one or more of each of the first unit UN1, the second unit UN2, the third unit UN3, and the fourth unit UN4. The sixteen units may be arranged, in various ways, such that units of a same type are not directly adjacent to each other in the first direction (X direction) and the second direction (Y direction). For example, identical units among the first unit UN1, the second unit UN2, the third unit UN3, and the fourth unit UN4 may be spaced apart from each other in the first direction (X direction) and the second direction (Y direction).

In the above descriptions, the pixel arrangement is based on that the units arranged within the unit pixel group PXG are in the 2×2, 3×3, and 4×4 formats, but embodiments are not limited thereto, and the pixel arrangement may expand to an arrangement of an N×N format, where N is an integer of 2 or more.

The areas of the sensor substrate 110, the nano optical lens array 130, and the color filter array 140, which are provided in the pixel arrays described with reference to FIGS. 13 to 21 may be sectioned to correspond to the color arrangements represented in the pixel arrangements described above.

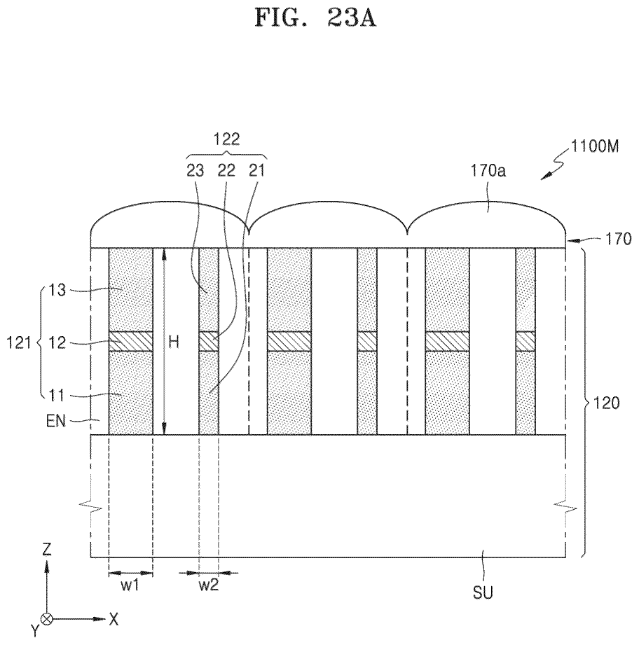

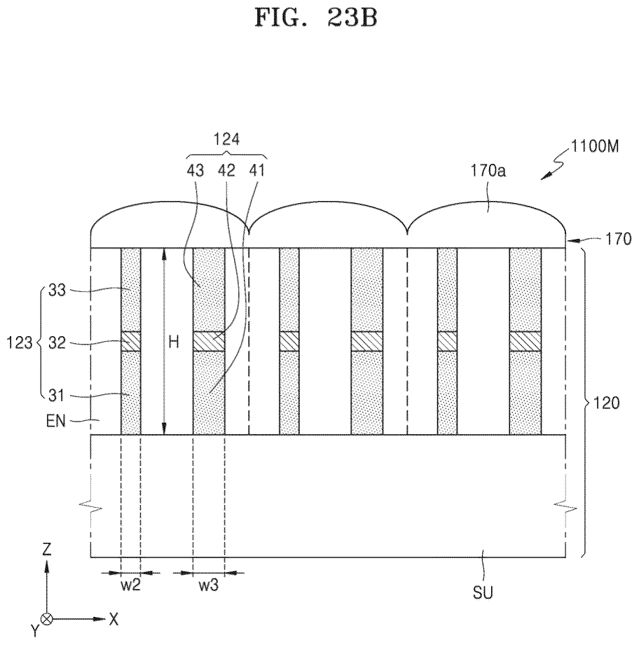

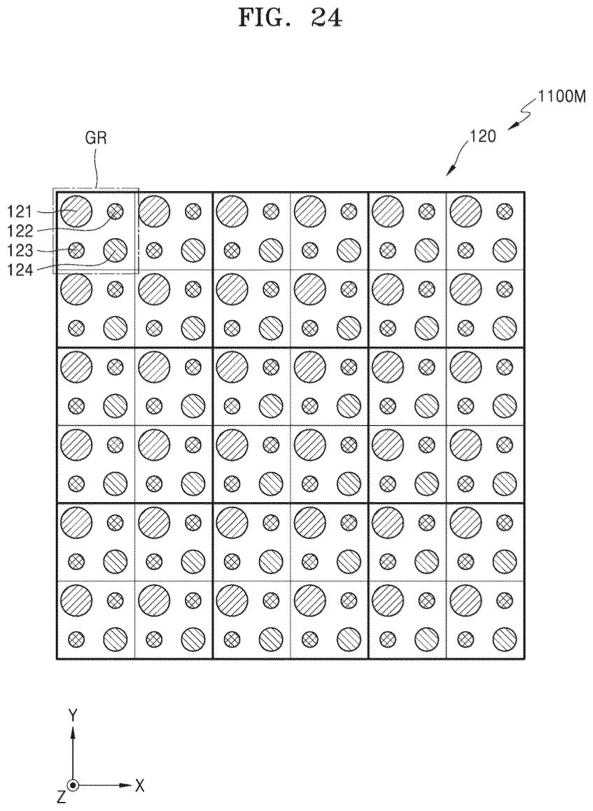

FIG. 22 is a perspective view schematically showing a configuration of a pixel array 1100M of an image sensor according to one or more other embodiments. FIGS. 23A and 23B are cross-sectional views schematically showing the configuration of the pixel array 1100M of the image sensor of FIG. 22. FIG. 24 is a plan view schematically showing a pixel arrangement of the pixel array 1100M of the image sensor of FIG. 22.

The pixel array 1100M of the image sensor according to the example embodiment may include photodiodes that sense incident light by separating the incident light by wavelength.

A sensor substrate 120 may include a plurality of unit pixel groups that are repeatedly arranged. The sensor substrate 120 may include a plurality of units GR that are repeatedly arranged, for example, one unit pixel group includes one unit GR. Each of the units GR may include a first photodiode 121 that selectively absorbs light of a red wavelength band, second and third photodiodes 122 and 123 that selectively absorb light of a green wavelength band, and a fourth photodiode 124 that selectively absorbs light of a blue wavelength band. The first photodiode 121 may be referred to as a red photodiode, the second and third photodiodes 122 and 123 may be referred to as green photodiodes, and the fourth photodiode 124 may be referred to as a blue photodiode.

The first to fourth photodiodes 121, 122, 123, and 124 are vertical photodiodes each having a rod shape in shape dimensions less than a wavelength of the incident light, and selectively absorb light of a specific wavelength band by waveguide mode-based resonance. The first photodiode 121, the second photodiode 122, and the fourth photodiode 124 may have widths of a cross section perpendicular to the height direction (Z direction) that are w1, w2, and w3, respectively. For example, a width of the first photodiode 121, a width of the second photodiode 122, and a width of the fourth photodiode 124 may be w1, w2, and w3, respectively in at least one of the first direction (X direction) and the second direction (Y direction). At least two widths among the three widths may be different from each other. As another example, all three widths are different from one another. The widths w1, w2, and w3 may each have a range of, for example, 50 nm to 200 nm. The widths w1, w2, and w3 may each be set such that, of the light incident on a unit pixel groups 120G, light of a wavelength satisfying each of waveguide mode resonance requirements may be guided inside a corresponding photodiode. For example, among the widths w1, w2, and w3, w1 may be greatest, and w2 may be smallest. For example, w1 may be about 100 nm, for example, in a range of 95 nm to 105 nm. w3 may be about 85 nm, for example, in a range of 80 nm to 90 nm. w2 may be about 60 nm, for example, in a range of 55 nm to 65 nm. Of the incident light, red light and blue light may be respectively absorbed by the first photodiode 121 having the width w1 and the fourth photodiode 124 having the width w3. Green light may be absorbed by the second photodiode 122 and the third photodiode 123, each having the width w2.

The first to fourth photodiodes 121, 122, 123, and 124 may be arranged such that, as illustrated in FIG. 24, lines connecting the centers of the first to fourth photodiodes 121, 122, 123, and 124 within one unit GR form a square. However, the arrangement is an example.

The height H of each of the first to fourth photodiodes 121, 122, 123, and 124 may be greater than or equal to about 500 nm, 1 μm, or 2 μm. The height may be set considering a location where the light incident on a photodiode is absorbed, for example, a depth location from a surface. Light of a shorter wavelength having high energy is absorbed at a position closer to an upper surface of a photodiode, and light of a longer wavelength is absorbed at a deeper position in a photodiode. The first to fourth photodiodes 121, 122, 123, and 124 may each have the same height as illustrated. When the first to fourth photodiodes 121, 122, 123, and 124 have the same height, generally, a manufacturing process may be easy. In this case, a height at which light absorption is sufficiently performed based on light of a long wavelength band may be set. However, embodiments are not limited thereto, and the heights of the first to fourth photodiodes 121, 122, 123, and 124 may vary depending on the wavelength of light to sense. An appropriate upper limit may be set considering quantum efficiency occurring by wavelength and process difficulties, and for example, the upper limit may be less than or equal to 10 μm or 5 μm.

The first to fourth photodiodes 121, 122, 123, and 124 are pin photodiodes of a rod shape. The first photodiode 121 may include a first conductive semiconductor layer 11, an intrinsic semiconductor layer 12, and a second conductive semiconductor layer 13. The second photodiode 122 may include a first conductive semiconductor layer 21, an intrinsic semiconductor layer 22, and a second conductive semiconductor layer 23, and the third photodiode 123 may include a first conductive semiconductor layer 31, an intrinsic semiconductor layer 32, and a second conductive semiconductor layer 33. The second photodiode 122 and the third photodiode 123, which are photodiodes for sensing green light, may be identical to each other. The fourth photodiode 124 may include a first conductive semiconductor layer 41, an intrinsic semiconductor layer 42, and a second conductive semiconductor layer 43. Although the first to fourth photodiodes 121, 122, 123, and 124 are illustrated as having a cylindrical shape, embodiments are not limited thereto. For example, the first to fourth photodiodes 121, 122, 123, and 124 may each have a polygonal column shape, such as a quadrangular column shape, a hexagonal column, etc.

The first to fourth photodiodes 121, 122, 123, and 124 may be formed based on a silicon semiconductor. For example, the first conductive semiconductor layers 11, 21, 31, and 41 may be p-Si, the intrinsic semiconductor layers 12, 22, 32, and 42 may be i-Si, and the second conductive semiconductor layers 13, 23, 33, and 43 may be n-Si. As another example, the first conductive semiconductor layers 11, 21, 31, and 41 may be n-Si, and the second conductive semiconductor layers 13, 23, 33, and 43 may be p-Si.

A surrounding material EN of the first to fourth photodiodes 121, 122, 123, and 124 may be air or a material having a lower refractive index than a refractive index of each of the first to fourth photodiodes 121, 122, 123, and 124. For example, SiO₂, Si₃N₄, or Al₂O₃ may be used as the surrounding material.

The sensor substrate 120 may further include a circuit substrate SU that supports the first to fourth photodiodes 121, 122, 123, and 124. The circuit substrate SU may not only support the first to fourth photodiodes 121, 122, 123, and 124, but also include a circuit element for processing electrical signals generated by the first to fourth photodiodes 121, 122, 123, and 124 which have absorbed light. For example, electrodes and wire structures for the first to fourth photodiodes 121, 122, 123, and 124 may be provided on the circuit substrate SU. Furthermore, various circuit elements needed for the image sensor 1000 may be arranged directly on the circuit substrate SU. For example, a logic layer including various analog circuits and digital circuits, or a memory layer for storing data may be provided on the circuit substrate SU. The logic layer and the memory layer may be formed in different layers or the same layer. Some of the circuit elements illustrated in FIG. 1 may be provided on the circuit substrate SU.

A micro lens array 170 may be further provided on the sensor substrate 120. The micro lens array 170 may include a plurality of micro lenses 170a, and each of the micro lenses 170a may face each of the units GR.

Furthermore, the pixel array 1100M may further include an optical diffuser. For example, the optical diffuser 150 described with reference to FIG. 10 may be provided with the micro lens array 170. The configuration of the micro lens array 170 or the optical diffuser may be changed to other optical elements.

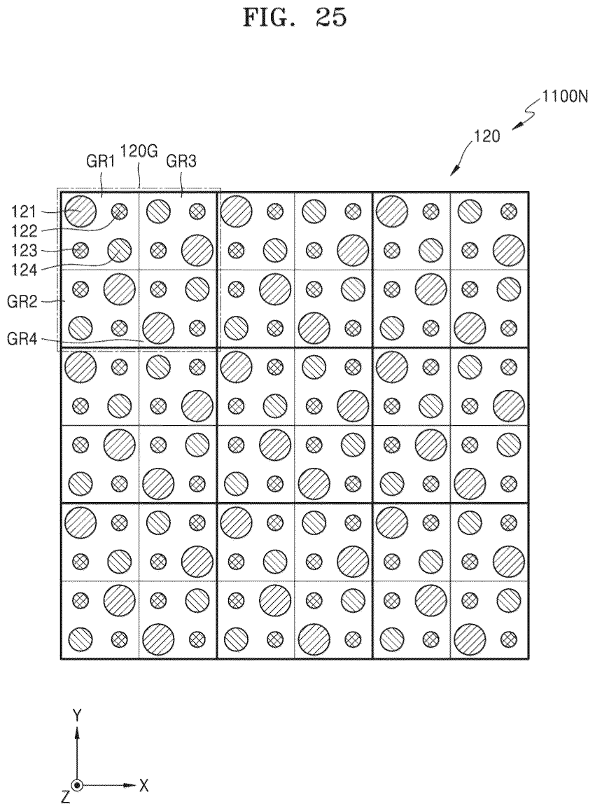

FIG. 25 is a plan view schematically showing a pixel arrangement of a pixel array 1100N of an image sensor according to one or more other embodiments.

The pixel array 1100N is similar to the pixel array 1100M described with reference to FIGS. 23A and 23B in that the pixel array 1100N includes the sensor substrate 120 that is photodiode-based and has a different cross-sectional size depending on the color to sense, and differs from the detailed arrangement of the first to fourth photodiodes 121, 122, 123, and 124.

Referring to FIG. 25, the sensor substrate 120 may include a plurality of unit pixel groups 120G that are repeatedly arranged, and each of the unit pixel groups 120G may include the first unit GR1, the second unit GR2, the third unit GR3, and the fourth unit GR4. The first unit GR1 is substantially the same as the units GR described with reference to FIG. 24, and the second unit GR2, the third unit GR3, and the fourth unit GR4 respectively correspond to the shapes of the first unit GR1 rotated by 90 degrees, 180 degrees, and 270 degrees with the third direction (Z direction) as an axis of rotation.

This arrangement corresponds to the same color arrangement as the color arrangement described with reference to FIG. 2.

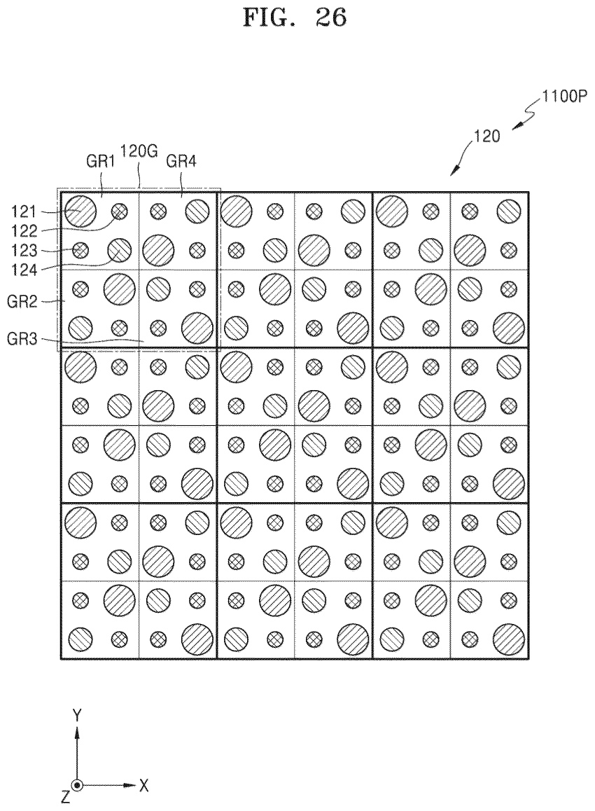

FIG. 26 is a plan view schematically showing a pixel arrangement of a pixel array 1100P of an image sensor according to one or more other embodiments.

The pixel array 1100P differs from the pixel array 1100N of FIG. 25 in the arrangement form of the first unit GR1, the second unit GR2, the third unit GR3, and the fourth unit GR4 constituting the unit pixel groups 120G. This configuration is an example of adopting the color arrangement of the pixel array 1100C described with reference to FIG. 13.

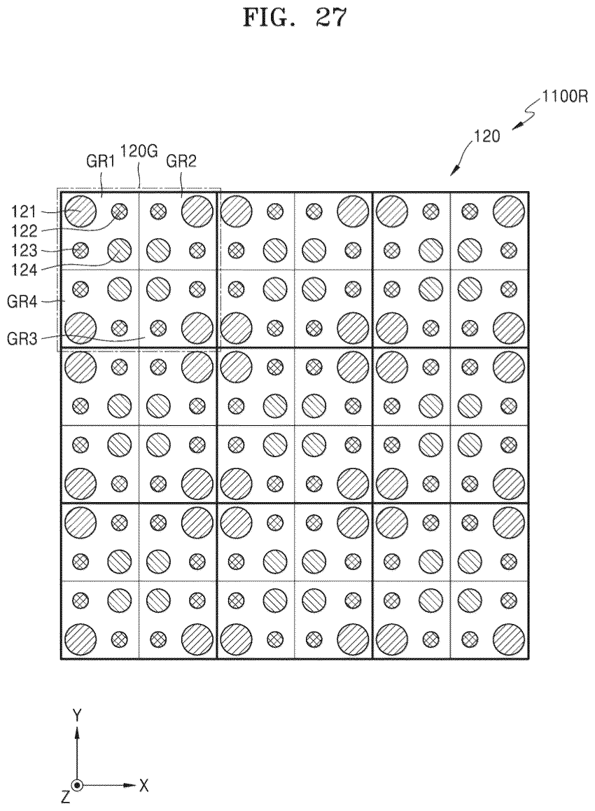

FIG. 27 is a plan view schematically showing a pixel arrangement of a pixel array 1100R of an image sensor according to one or more other embodiments.

The pixel array 1100R differs from the pixel array 1100N of FIG. 25 in the arrangement form of the first unit GR1, the second unit GR2, the third unit GR3, and the fourth unit GR4 constituting the unit pixel groups 120G. This configuration is an example of adopting the color arrangement of the pixel array 1100D described with reference to FIG. 14.

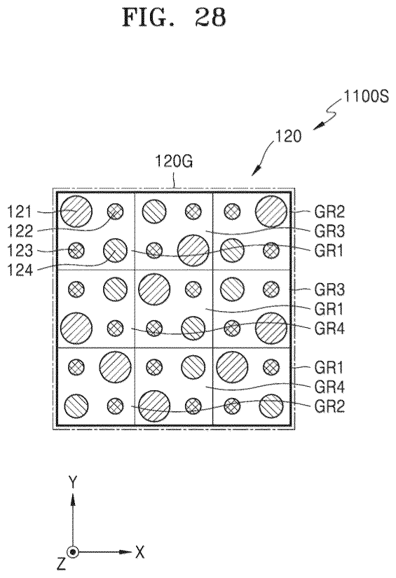

FIG. 28 is a plan view schematically showing a pixel arrangement of a pixel array 1100S of an image sensor according to one or more other embodiments.

FIG. 28 illustrates one of the unit pixel groups 120G that is repeatedly arranged and included in the sensor substrate 120 of the pixel array 1100S. This configuration is an example of adopting the color arrangement of the pixel array 1100H of FIG. 18.

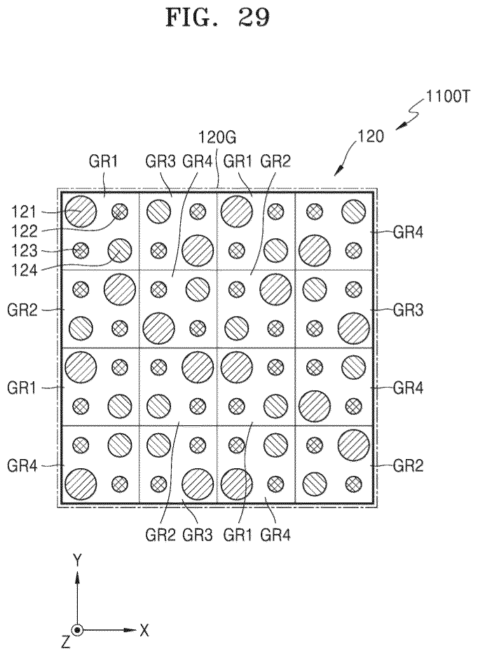

FIG. 29 is a plan view schematically showing a pixel arrangement of a pixel array 1100T of an image sensor according to one or more other embodiments.

FIG. 29 illustrates one of the unit pixel groups 120G that is repeatedly arranged and included in the sensor substrate 120 of the pixel array 1100T. This configuration is an example of adopting the color arrangement of the pixel array 1100K of FIG. 20.

The image sensor described FIGS. 22 to 24, which includes photodiodes having different cross-sectional sizes depending on the color of light to sense, may adopt various arrangements other than the photodiode arrangements described as examples in FIGS. 25 to 29. For example, various color arrangements as described with reference to FIGS. 13 to 20 may be adopted.

The image sensor 1000 according to one or more embodiments may constitute a camera module with a module lens with various performance, or used for various electronic apparatuses.

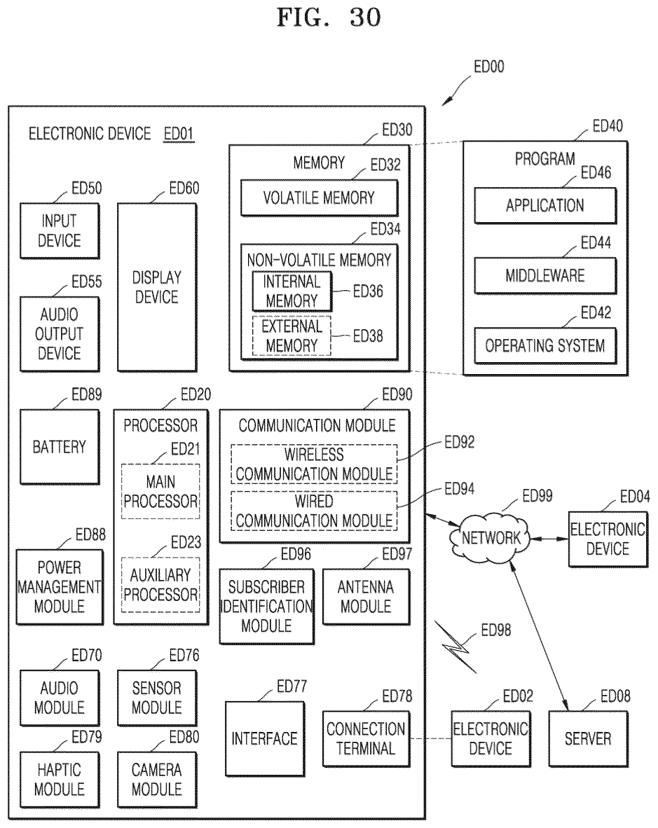

FIG. 30 is a block diagram schematically showing a configuration of an electronic apparatus ED01 including the image sensor 1000. Referring to FIG. 30, in a network environment ED00, an electronic device ED01 may communicate with another electronic device ED02 through a first network ED98 (a short-range wireless communication network, etc.), or communicate with another electronic device ED04 and/or a server ED08 through a second network ED99 (a long-range wireless communication network, etc.). The electronic device ED01 may communicate with the electronic device ED04 through the server ED08. The electronic device ED01 may include a processor ED20, a memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. In the electronic device ED01, some of the constituent elements (the display device ED60, etc.) may be omitted or another constituent element may be added. Some of these constituent elements may be implemented as one integrated circuit. For example, the sensor module ED76 (a fingerprint sensor, an iris sensor, an illuminance sensor, etc.) may be implemented by being embedded in the display device ED60 (a display etc.).

The processor ED20 may control, by executing software (a program ED40, etc.), one or a plurality of other constituent elements (a hardware or software constituent element, etc.) of the electronic device ED01, and perform various data processing or operations. As part of the data processing or operations, the processor ED20 may load commands and/or data received from other constituent elements (the sensor module ED76, the communication module ED90, etc.) in a volatile memory ED32, process the command and/or data stored in the volatile memory ED32, and store resultant data in a non-volatile memory ED34. The processor ED20 may include a main processor ED21 (a central processing unit, an application processor, etc.) and an auxiliary processor ED23 (a graphics processing unit, an image signal processor, a sensor hub processor, a communication processor, etc.), which are operable independently or together. The auxiliary processor ED23 may consume less power than the main processor ED21 and may perform a specialized function.

The auxiliary processor ED23 may control functions and/or states related to some constituent elements (the display device ED60, the sensor module ED76, the communication module ED90, etc.) of the electronic device ED01, instead of the main processor ED21 when the main processor ED21 is in an inactive state (a sleep state), or with the main processor ED21 when the main processor ED21 is in an active state (an application execution state). The auxiliary processor ED23 (an image signal processor, a communication processor, etc.) may be implemented as a part of functionally related other constituent elements (the camera module ED80, the communication module ED90, etc.).

The memory ED30 may store various pieces of data needed for constituent element (the processor ED20, the sensor module ED76, etc.) of the electronic device ED01. The data may include, for example, software (the program ED40 etc.) and input data and/or output data regarding commands related thereto. The memory ED30 may include the volatile memory ED32 and/or the non-volatile memory ED34.

The program ED40 may be stored as software in the memory ED30, and may include an operating system ED42, a middleware ED44, and/or an application ED46.

The input device ED50 may receive commands and/or data to be used in the constituent elements (the processor ED20 etc.) of the electronic device ED01, from the outside (a user etc.) of the electronic device ED01. The input device ED50 may include a microphone, a mouse, a keyboard, and/or a digital pen (a stylus pen etc.).

The audio output device ED55 may output an audio signal to the outside of the electronic device ED01. The audio output device ED55 may include a speaker and/or a receiver. The speaker may be used for general purposes such as multimedia playback or recording playback, and the receiver may be used to receive incoming calls. The receiver may be combined as a part of the speaker or implemented as an independent separate device.

The display device ED60 may visually provide information to the outside of the electronic device ED01. The display device ED60 may include a display, a hologram device, or a projector, and a control circuit for controlling such a device. The display device ED60 may include a touch circuitry set to sense a touch, and/or a sensor circuit (a pressure sensor etc.) set to measure the strength of a force generated by the touch.

The audio module ED70 may convert sound into an electrical signal or reversely an electrical signal into sound. The audio module ED70 may obtain sound through the input device ED50, or output sound through the audio output device ED55 and/or a speaker and/or a headphone of another electronic device (the electronic device ED02, etc.) connected to the electronic device ED01 in a wired or wireless manner.

The sensor module ED76 may sense an operation state (power, a temperature, etc.) of the electronic device ED01, or an external environment state (a user state etc.), and generate an electrical signal and/or data value corresponding to a sensed state. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or more designated protocols to be used for connecting the electronic device ED01 to another electronic device (the electronic device ED02, etc.) in a wired or wireless manner. The interface ED77 may include a high definition multimedia interface (HDMI), a universal serial bus (USB) interface, an SD card interface, and/or an audio interface.

A connection terminal ED78 may include a connector for physically connecting the electronic device ED01 to another electronic device (the electronic device ED02, etc.). The connection terminal ED78 may include an HDMI connector, a USB connector, an SD card connector, and/or an audio connector (a headphone connector etc.).

The haptic module ED79 may convert electrical signals into mechanical stimuli (vibrations, movements, etc.) or electrical stimuli that are perceivable by a user through tactile or motor sensations. The haptic module ED79 may include a motor, a piezoelectric device, and/or an electrical stimulation device.

The camera module ED80 may capture a still image and a video. The camera module ED80 may include a lens assembly including one or a plurality of lenses, image sensors, image signal processors, and/or flashes. The lens assembly included in the camera module ED80 may collect light emitted from an object that is a target for image capturing.

The power management module ED88 may manage power supplied to the electronic device ED01. The power management module ED88 may be implemented as a part of a power management integrated circuit (P MIC).

The battery ED89 may supply power to the constituent elements of the electronic device ED01. The battery ED89 may include non-rechargeable primary cells, rechargeable secondary cells, and/or fuel cells.

The communication module ED90 may establish a direct (wired) communication channel and/or a wireless communication channel between the electronic device ED01 and another electronic device (the electronic device ED02, the electronic device ED04, the server ED08, etc.), and support a communication through an established communication channel. The communication module ED90 may be operated independently of the processor ED20 (the application processor etc.), and may include one or a plurality of communication processors supporting a direct communication and/or a wireless communication. The communication module ED90 may include a wireless communication module ED92 (a cellular communication module, a short-range wireless communication module, a global navigation satellite system (GNSS) communication module, etc.), and/or a wired communication module ED94 (a local area network (LAN) communication module, a power line communication module, etc.). Among the above communication modules, a corresponding communication module may communicate with another electronic device through the first network ED98 (a short-range communication network such as Bluetooth, WiFi Direct, or infrared data association (IrDA)) or the second network ED99 (a long-range communication network such as a cellular network, the Internet, or a computer network (LAN, WAN, etc.)). These various types of communication modules may be integrated into one constituent element (a single chip, etc.), or may be implemented as a plurality of separate constituent elements (multiple chips). The wireless communication module ED92 may verify and authenticate the electronic device ED01 in a communication network such as the first network ED98 and/or the second network ED99 by using subscriber information (an international mobile subscriber identifier (IMSI), etc.) stored in the subscriber identification module ED96.

The antenna module ED97 may transmit signals and/or power to the outside (another electronic device etc.) or receive signals and/or power from the outside. An antenna may include an emitter formed in a conductive pattern on a substrate (a printed circuit board (PCB) etc.). The antenna module ED97 may include one or a plurality of antennas. When the antenna module ED97 includes a plurality of antennas, the communication module ED90 may select, from among the antennas, an appropriate antenna for a communication method used in a communication network such as the first network ED98 and/or the second network ED99. Signals and/or power may be transmitted or received between the communication module ED90 and another electronic device through the selected antenna. Other parts (an RFIC etc.) than the antenna may be included as a part of the antenna module ED97.

Some of the constituent elements may be connected to each other through a communication method between peripheral devices (a bus, general purpose input and output (GPIO), a serial peripheral interface (SPI), a mobile industry processor interface (MIPI), etc.) and may mutually exchange signals (commands, data, etc.).

The command or data may be transmitted or received between the electronic device ED01 and the external electronic device ED04 through the server ED08 connected to the second network ED99. The electronic devices ED02 and ED04 may be of a type that is the same as or different from the electronic device ED01. All or a part of operations executed in the electronic device ED01 may be executed in one or a plurality of other electronic devices (ED02, ED04, and ED08). For example, when the electronic device ED01 needs to perform a function or service, the electronic device ED01 may request one or a plurality of other electronic devices to perform part or the whole of the function or service, instead of performing the function or service by itself. The one or a plurality of the electronic devices receiving the request may perform additional functions or services related to the request and transmit a result of the performance to the electronic device ED01. To this end, cloud computing, distributed computing, and/or client-server computing technology may be used.

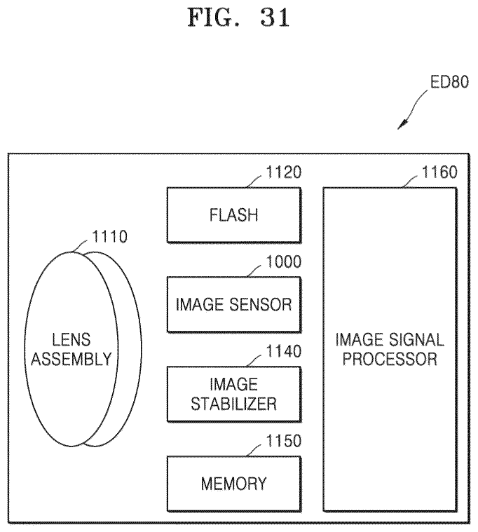

FIG. 31 is a block diagram schematically showing the camera module ED80 of the electronic apparatus ED01 of FIG. 30. Referring to FIG. 30, the camera module ED80 may include a lens assembly 1110, a flash 1120, the image sensor 1000, an image stabilizer 1140, a memory 1150 (a buffer memory, etc.), and/or an image signal processor 1160. The lens assembly 1110 may collect light emitted from an object for image capturing. The camera module ED80 may include a plurality of lens assemblies 1110, and in this case, the camera module ED80 may include a dual camera, a 360 degrees camera, or a spherical camera. Some of the lens assemblies 1110 may have the same lens attributes (a field of view, a focal length, an autofocus, an F number, an optical zoom, etc.), or other lens attributes. The lens assembly 1110 may include a wide-angle lens or a telephoto lens.

The flash 1120 may emit light used to reinforce light emitted or reflected from the object. The flash 1120 may emit visible light or infrared light. The flash 1120 may include one or a plurality of light-emitting diodes (LEDs) (a red- green-blue (RGB) LED, a white LED, an infrared LED, an ultraviolet LED, etc.), and/or a xenon lamp. The image sensor 1000 may be the image sensor described with reference to FIG. 1, and may convert light emitted or reflected from the object and transmitted through the lens assembly 1110 into electrical signals, thereby obtaining an image corresponding to the object.

The image stabilizer 1140 may move, in response to a movement of the camera module ED80 or an electronic apparatus including the same, one or a plurality of lens included in the lens assembly 1110 or the image sensor 1000 in a specific direction, or may compensate a negative effect due to the movement by controlling (adjusting a read-out timing, etc.) the operational characteristics of the image sensor 1000. The image stabilizer 1140 may detect a movement of the camera module ED80 or the electronic apparatus ED01 by using a gyro sensor (not shown) or an acceleration sensor (not shown) arranged inside or outside the camera module ED80. The image stabilizer 1140 may be implemented in an optical form.

The memory 1150 may store a part or entire data of an image obtained through the image sensor 1000 for a subsequent image processing operation. For example, when a plurality of images are obtained at high speed, only low resolution images are displayed while the obtained original data (Bayer-patterned data, high resolution data, etc.) is stored in the memory 2350. Then, the original data of a selected (user selection, etc.) image may be transmitted to the image signal processor 1160 The memory 1150 may be incorporated into the memory ED30 of the electronic device ED01, or configured to be an independently operated separate memory.

The image signal processor 1160 may obtain an image using the electrical signals output from the image sensor 1000. For example, the image signal processor 1160 may directly perform some of the image processing illustrated in FIG. 8 in association with the image sensor 1000. Furthermore, the image signal processor 1160 may request the image sensor 1000 for image data in a specific format according to the format of image data that is needed.

Furthermore, the image signal processor 1160 may perform one or more image processing on the image obtained through the image sensor 1000 or the image data stored in the memory 1150. The image processing may include depth map generation, three-dimensional modeling, panorama generation, feature point extraction, image synthesis, and/or image compensation (noise reduction, resolution adjustment, brightness adjustment, blurring, sharpening, softening, etc.) The image signal processor 1160 may perform control (exposure time control, or read-out timing control, etc.) on constituent elements (the image sensor 1000, etc.) included in the camera module ED80.

The image processed by the image signal processor 1160 may be stored again in the memory 1150 for additional processing or provided to external constituent elements (the memory ED30, the display apparatus ED60, the electronic device ED02, the electronic device ED04, the server ED08, etc.) of the camera module ED80. The image signal processor 1160 may be incorporated into the processor ED20, or configured to be a separate processor operated independently of the processor ED20. When the image signal processor 1160 is configured by a separate processor from the processor ED20, the image processed by the image signal processor 1160 may undergo additional image processing by the processor ED20 and then displayed through the display apparatus ED60.

Furthermore, the image signal processor 1160 may independently receive two output signals from adjacent light-sensing cells within each pixel or sub pixel of the image sensor 1000, and may generate an autofocus signal from a difference between the two output signals. The image signal processor 1160 may control the lens assembly 1110 based on the autofocus signal such that the focus of the lens assembly 1110 is accurately formed on the surface of the image sensor 1000.

The electronic apparatus ED01 may further include additional one or a plurality of camera modules, each having a different attribute or function. The above camera module may have a configuration similar to the camera muddle ED80 of FIG. 31, and an image sensor provided in the camera module may be implemented by a CCD sensor and/or a CMOS sensor, and may include one or a plurality of sensors selected from image sensors, such as an RGB sensor, a black and white (BW) sensor, an IR sensor, or a UV sensor, having different attributes. In this case, one of the camera modules ED80 may be a wide-angle camera, and the other may be telephoto camera. Similarly, one of the camera modules ED80 is a front-side camera, and the other may be a rear-side camera.

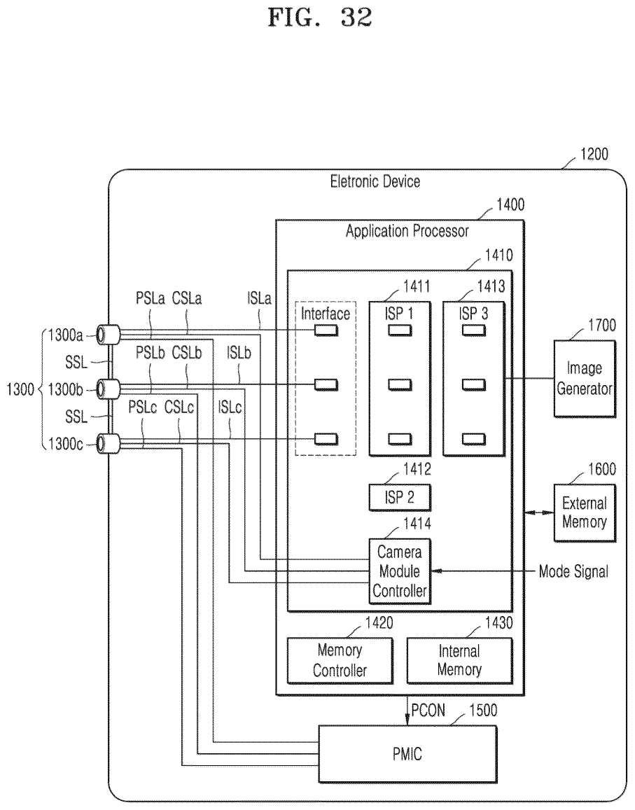

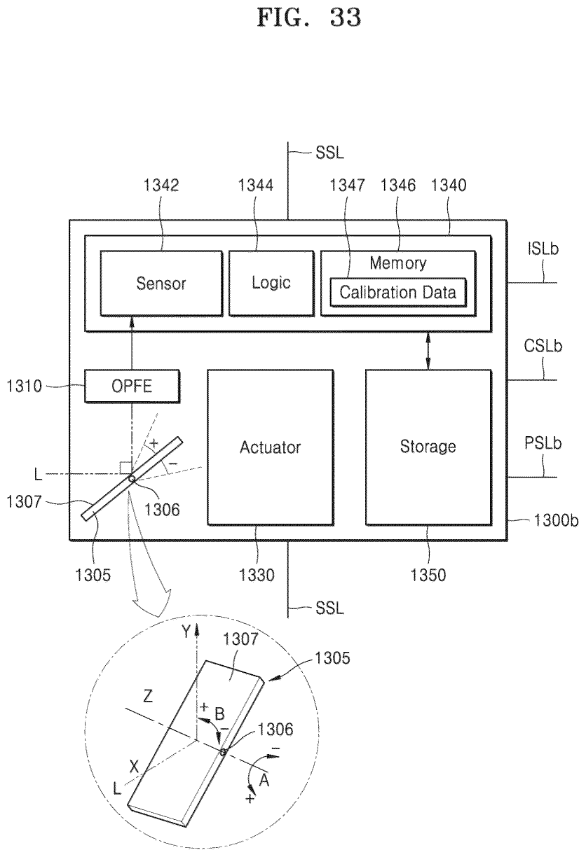

FIG. 32 is a block diagram of an electronic device 1200 including a multi-camera module, and FIG. 33 is a detailed block diagram of one camera module of the electronic device 1200 of FIG. 32.

Referring to FIG. 32, the electronic device 1200 may include a camera module group 1300, an application processor 1400, a power management integrated circuit (PMIC) 1500, an external memory 1600, and an image generator 1700.

The camera module group 1300 may include a plurality of camera modules 1300a, 1300b, and 1300c. Although one or more embodiments in which the three camera modules 1300a, 1300b, and 1300c are arranged is illustrated in the drawing, embodiments are not limited thereto. In some embodiments, the camera module group 1300 may be implemented to be modified to include only two camera modules. Furthermore, in some embodiments, the camera module group 1300 may be implemented to be modified to include n camera modules, where n is a natural number of 4 or more.

A configuration of the camera module 1300b is described below in detail with reference to FIG. 33, and the descriptions below may be identically applied to the other camera modules 1300a and 1300c according to embodiments.

Referring to FIG. 33, the camera module 1300b may include a prism 1305, an optical path folding element (OPFE) 1310, an actuator 1330, an image sensing device 1340, and a storage 1350.

The prism 1305 may include a reflective surface 1307 including a light reflecting material to change a path of light L incident from the outside.

In some embodiments, the prism 1305 may change the path of the light L incident in a first direction X to the second direction (Y direction) perpendicular to the first direction (X direction). Furthermore, the prism 1305 may change the path of the light L incident in the first direction X to the second direction (Y direction) that is perpendicular to the first direction X by rotating the reflective surface 1307 of the light reflecting material around a center axis 1306 in an A direction, or rotating the center axis 1306 in a B direction. In this state, the OPFE 1310 may be moved in the first direction (X direction) and a third direction (Z direction) perpendicular to the second direction (Y direction).

In some embodiments, as illustrated in the drawing, the maximum rotation angle in A direction of the prism 1305 may be 15 degrees or less in a (+) A direction and great than 15 degrees in a (−) A direction, but embodiments are not limited thereto.

In some embodiments, the prism 1305 may move around 20 degrees, from 10 degrees to 20 degrees, or from 15 degrees to 20 degrees, in a (+) or (−) B direction. The prism 1305 may move at the same angle, or an almost similar angle within a range of 1 degree, in the (+) or (−) B direction.

In some embodiments, the prism 1305 may move the reflective surface 1307 of the light reflecting material in the third direction (e.g., the Z direction) parallel to an extension direction of the center axis 1306.

The OPFE 1310 may include an optical lens including, for example, m groups, where m is a natural number. As m lenses move in the second direction (Y direction), an optical zoom ratio of the camera module 1300b may be changed. For example, in a case in which a basic optical zoom ratio of the camera module 1300b is Z, when m optical lenses included in the OP FE 1310 are moved, the optical zoom ratio of the camera module 1300b may be changed to an optical zoom ratio of 3Z, 5Z, or 10Z or more.

The actuator 1330 may move the OPFE 1310 or an optical lens (hereinafter, both referred to as the optical lens) to a specific position. For example, the actuator 1330 may adjust the position of the optical lens such that, for accurate sensing, an image sensor 1342 is located at a focal length of the optical lens.

The image sensing device 1340 may include the image sensor 1342, a control logic 1344, and a memory 1346. The image sensor 1342 may sense an image to sense by using the light L provided through the optical lens. The control logic 1344 may control the overall operation of the camera module 1300b. For example, the control logic 1344 may control the operation of the camera module 1300b in response to a control signal provided through a control signal line CSLb.

The memory 1346 may store information, such as calibration data 1347, needed for the operation of the camera module 1300b. The calibration data 1347 may include information needed to generate image data by using the light L provided from the outside through the camera module 1300b. The calibration data 1347 may include, for example, information about a degree of rotation, information about a focal length, information about an optical axis, and the like, which are described above. When the camera module 1300b is implemented in the form of a multi-state camera having a focal length varying depending on the position of the optical lens, the calibration data 1347 may include a focal length value of the optical lens for each position (or for each state) and information related to auto-focusing.

The storage 1350 may store image data sensed through the image sensor 1342. The storage 1350 may be arranged outside the image sensing device 1340, and may be implemented by being stacked with a sensor chip constituting the image sensing device 1340. In some embodiments, the storage 1350 may be implemented by electrically erasable programmable read-only memory (EEPROM), but embodiments are not limited thereto.

Referring to FIGS. 32 and 33 together, in some embodiments, each of the camera modules 1300a, 1300b, and 1300c may include the actuator 1330. Accordingly, the camera modules 1300a, 1300b, and 1300c may each include the calibration data 1347 which are the same as or different from one another according to the operation of the actuator 1330 included therein.

In some embodiments, among the camera modules 1300a, 1300b, and 1300c, one camera module (e.g., 1300b) may be a camera module in the form of a folded lens including the prism 1305 and the OPFE 1310 described above, and the other camera modules (e.g., 1300a and 1300b) may each be a camera module in a vertical form that does not include the prism 1305 and the OPFE 1310, but embodiments are not limited thereto.

In some embodiments, one camera module (e.g., 1300c) of the camera modules 1300a, 1300b, and 1300c may be for example, a depth camera of a vertical form which extracts depth information using IR Ray.

In some embodiments, at least two camera modules (e.g., 1300a and 1300b) of the camera modules 1300a, 1300b, and 1300c may have different observation fields (a field of view or a viewing angle). In this case, for example, at least two camera modules (e.g., 1300a and 1300b) of the camera modules 1300a, 1300b, and 1300c may have different optical lenses, but embodiments are not limited thereto.

Furthermore, in some embodiments, the camera modules 1300a, 1300b, and 1300c may have viewing angles different from each other. In this case, the optical lenses respectively included in the camera modules 1300a, 1300b, and 1300c may be different from one another, but embodiments are not limited thereto.

In some embodiments, the camera modules 1300a, 1300b, and 1300c may be physically separated from one another. For example, it is not that a sensing area of one image sensor (e.g., the image sensor 1342) is divided and used by the camera modules 1300a, 1300b, and 1300c, but that an independent image sensor (e.g., the image sensor 1342) may be arranged in each of the camera modules 1300a, 1300b, and 1300c.

Referring back to FIG. 32, the application processor 1400 may include an image processing device 1410, a memory controller 1420, and an internal memory 1430. The application processor 1400 may be implemented separately from the camera modules 1300a, 1300b, and 1300c. For example, the application processor 1400 and the camera modules 1300a, 1300b, and 1300c may be implemented separately from each other as separate semiconductor chips.

The image processing device 1410 may include a plurality of image processors 1411, 1412, and 1413, and a camera module controller 1414.

The image data generated by each of the camera modules 1300a, 1300b, and 1300c may be provided to the image processing device 1410 through image signal lines ISLa, ISLb, and ISLc which are separated from one another. The transmission of image data may be performed using, for example, a camera serial interface (CSI) based on a mobile industry processor interface (MIPI), but embodiments are not limited thereto.

The image data transmitted to the image processing device 1410 may be stored in the external memory 1600 before transmitted to the image processors 1411 and 1412. The image data stored in the external memory 1600 may be provided to the image processor 1411 and/or the image processor 1412. The image processor 1411 may correct received image data to generate a video. The image processor 1412 may correct received image data to generate a still image. For example, the image processors 1411 and 1412 may perform a pre-processing operation, such as color correction, gamma correction, and the like, on the image data.

The image processor 1411 may include sub-processors. When the number of sub-processors is the same as the number of the camera modules 1300a, 1300b, and 1300c, each of the sub-processors may process image data provided by one camera module. When the number of sub-processors is less than the number of the camera modules 1300a, 1300b, and 1300c, at least one of the sub-processors may process image data provided by a plurality of camera modules using a timing sharing process. The image data processed by the image processor 1411 and/or the image processor 1412 may be stored in the external memory 1600 before transmitted to the image processor 1413. The image data stored in the external memory 1600 may be transmitted to the image processor 1412. The image processor 1412 may perform a post-processing operation, such as noise correction, sharpen correction, and the like, on the image data.

The image data processed by the image processor 1413 may be provided to the image generator 1700. The image generator 1700 may generate a final image using the image data provided from the image processor 1413 according to image generating information or a mode signal.

In detail, the image generator 1700 may generate an output image by merging at least parts of the image data generated by the camera modules 1300a, 1300b, and 1300c having different viewing angles, according to the image generating information or the mode signal. Furthermore, the image generator 1700 may generate an output image by selecting any one of the image data generated by the camera modules 1300a, 1300b, and 1300c having different viewing angles, according to the image generating information or the mode signal.

In some embodiments, the image generating information may include a zoom signal or a zoom factor. Furthermore, in some embodiments, the mode signal may be, for example, a signal based on a mode selected by a user.

When the image generating information is a zoom signal or a zoom factor and each of the camera modules 1300a, 1300b, and 1300c has different observation fields (viewing angles), the image generator 1700 may perform a different operation depending on the type of the zoom signal. For example, when the zoom signal is a first signal, the image data output from the camera module 1300a and the image data output from the camera module 1300c are merged with each other, and then, an output image may be generated using a merged image signal and the image data output from the camera module 1300b that is not used for merging. When the zoom signal is a second signal different from the first signal, the image generator 1700 may not perform the image data merger, and may generate an output image by selecting any one of the image data respectively output from the camera modules 1300a, 1300b, and 1300c. However, embodiments are not limited thereto, and a method of processing image data may be modified and performed, as necessary.

The camera module controller 1414 may provide a control signal to each of the camera modules 1300a, 1300b, and 1300c. The control signal generated by the camera module controller 1414 may be provided to the corresponding camera modules 1300a, 1300b, and 1300c through the control signal lines CSLa, CSLb, and CSLc separated from one another.

In some embodiments, the control signals provided from the camera module controller 1414 to the camera modules 1300a, 1300b, and 1300c may include mode information according to the mode signal. The camera modules 1300a, 1300b, and 1300c may operate a first operation mode and a second operation mode in relation with a sensing speed, based on the mode information.

The camera modules 1300a, 1300b, and 1300c, in the first operation mode, may generate an image signal at a first speed (e.g., generating an image signal at a first frame rate) and encode the generated image signal at a second speed greater than the first speed (e.g., encoding an image signal at a second frame rate greater than the first frame rate), and transmit the encoded image signal to the application processor 1400. In this state, the second speed may be less than or equal to 30 times of the first speed.

The application processor 1400 may store the received image signal, that is, the encoded image signal, in the internal memory 1430 provided inside the application processor 1400 or the external storage 1600 provided outside the application processor 1400. Then, the application processor 1400 may read and decode the encoded image signal from the internal memory 1430 or the external storage 1600 and display image data generated based on the decoded image signal. For example, the image processors 1411 and 1412 of the image processing device 1410 may perform decoding, and furthermore, perform image processing on the decoded image signal.

The camera modules 1300a, 1300b, and 1300c, in the second operation mode, may generate an image signal at a third speed less than the first speed (e.g., generating an image signal at a third frame rate less than the first frame rate), and transmit the image signal to the application processor 1400. The image signal provided to the application processor 1400 may be a signal that is not encoded. The application processor 1400 may perform image processing on the received image signal or store the image signal in the internal memory 1430 or the external storage 1600.

The PMIC 1500 may supply power, for example, a power voltage, to each of the camera modules 1300a, 1300b, and 1300c. For example, the PMIC 1500, under the control of the application processor 1400, may supply first power to the camera module 1300a through a power signal line PSLa, second power to the camera module 1300b through a power signal line PSLb, and third power to the camera module 1300c through a power signal line PSLc.

The PMIC 1500, in response to a power control signal PCON from the application processor 1400, may generate power corresponding to each of the camera modules 1300a, 1300b, and 1300c and furthermore adjust a level of the power. The power control signal PCON may include a power adjustment signal for each operation mode of the camera modules 1300a, 1300b, and 1300c. For example, the operation mode may include low power mode, and in this state, the power control signal PCON may include information about a camera module operating in a low power mode and a set power level. The levels of powers respectively supplied to the camera modules 1300a, 1300b, and 1300c may be the same as or different from each other. Furthermore, the power level may be dynamically changed.

According to the image sensor described above, resolution deterioration or occurrence of aliasing (false color) due to down sampling during image processing may be reduced.

It should be understood that the image sensor and the electronic apparatus including the same described herein should be considered in a descriptive sense only and not for purposes of limitation.

Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An image sensor comprising:
a sensor substrate comprising a plurality of unit pixel groups in two dimensions in a first direction and a second direction, each unit pixel group among the plurality of unit pixels groups comprising a plurality of pixels configured to detect light; and
an optical element on the sensor substrate and configured to focus incident light onto each pixel of the plurality of pixels,
wherein each unit pixel group of the plurality of unit pixel groups comprises:
a first unit comprising a red pixel, two green pixels, and a blue pixel, which are in a 2×2 format in the first direction and the second direction, the two green pixels being adjacent to each other in a diagonal direction;
a second unit having a structure of the first unit rotated by 90 degrees with respect to a third direction perpendicular to the first direction and the second direction as an axis of rotation;
a third unit having a structure of the first unit rotated by 180 degrees with respect to the third direction as an axis of rotation; and
a fourth unit having a structure of the first unit rotated by 270 degrees with respect to the third direction as an axis of rotation.

2. The image sensor of claim 1, wherein the image sensor is configured to obtain pieces of information with respect to red light, green light, and blue light, each having same space information, from each of the first unit, the second unit, the third unit, and the fourth unit.

3. The image sensor of claim 1, wherein each pixel group of the plurality of unit pixel groups comprises the first unit, the second unit, the third unit, and the fourth unit, and
wherein the first unit, the second unit, the third unit, and the fourth unit are in a 2×2 format in the first direction and the second direction.

4. The image sensor of claim 1, wherein each unit pixel group of the plurality of unit pixel groups comprises nine units from among the first unit, the second unit, the third unit, and the fourth unit, the nine units comprising one or more of each of the first unit, the second unit, the third unit, and the fourth unit, and
wherein the nine units are in a 3×3 format in the first direction and the second direction, identical units among the first unit, the second unit, the third unit, and the fourth unit being spaced apart from each other in the first direction or the second direction.

5. The image sensor of claim 1, wherein each unit pixel group of the plurality of unit pixel groups comprises sixteen units from among the first unit, the second unit, the third unit, and the fourth unit, the sixteen units comprising one or more of each of the first unit, the second unit, the third unit, and the fourth unit, and
wherein the sixteen units are in a 4×4 format in the first direction and the second direction, identical units among the first unit, the second unit, the third unit, and the fourth unit being spaced apart from each other in the first direction or the second direction.

6. The image sensor of claim 1, wherein the optical element comprises a nano optical lens array,
wherein the nano optical lens array comprises a first unit structure, a second unit structure, a third unit structure, and a fourth unit structure corresponding to the first unit, the second unit, the third unit, and the fourth unit, respectively, wherein each of the first unit structure, the second unit structure, the third unit structure, and the fourth unit structure comprises a plurality of areas corresponding to the plurality of pixels, respectively, and
wherein each of the first unit structure, the second unit structure, the third unit structure, and the fourth unit structure comprises a plurality of nanostructures configured to color-separate incident light to be focused on each pixel of the plurality of pixels.

7. The image sensor of claim 6, wherein the plurality of nanostructures are configured such that no light exchange occurs between the first unit structure, the second unit structure, the third unit structure, and the fourth unit structure, and color separation and focusing occur independently within each of the first unit structure, the second unit structure, the third unit structure, and the fourth unit structure.

8. The image sensor of claim 6, further comprising an optical diffuser on the nano optical lens array.

9. The image sensor of claim 6, further comprising a color filter array between the nano optical lens array and the sensor substrate.

10. The image sensor of claim 1, wherein the red pixel comprises a red photodiode configured to selectively absorb light of a red wavelength band and has a first width in one of the first direction and the second direction,
wherein each green pixel among the two green pixels comprises a green photodiode configured to selectively absorb light of a green wavelength band and has a second width in one of the first direction and the second direction,
wherein the blue pixel comprises a blue photodiode configured to selectively absorb light of a blue wavelength band and has a third width in one of the first direction and the second direction, and
wherein at least two widths among the first width, the second width, and the third width are different from each other.

11. The image sensor of claim 10, wherein each unit pixel group of the plurality of unit pixel groups comprises the first unit, the second unit, the third unit, and the fourth unit, and
wherein the first unit, the second unit, the third unit, and the fourth unit are in a 2×2 format in the first direction and the second direction.

12. The image sensor of claim 10, wherein each unit pixel group of the plurality of unit pixel groups comprises nine units from among the first unit, the second unit, the third unit, and the fourth unit, the nine units comprising one or more of each of the first unit, the second unit, the third unit, and the fourth unit, and
wherein the nine units are in a 3×3 format in the first direction and the second direction, identical units among the first unit, the second unit, the third unit, and the fourth unit being spaced apart from each other in the first direction or the second direction.

13. The image sensor of claim 10, wherein each unit pixel group of the plurality of unit pixel groups comprises sixteen units from among the first unit, the second unit, the third unit, and the fourth unit, the sixteen units comprising one or more of each of the first unit, the second unit, the third unit, and the fourth unit, and
wherein the sixteen units are in a 4×4 format in the first direction and the second direction, identical units among the first unit, the second unit, the third unit, and the fourth unit being spaced apart from each other in the first direction or the second direction.

14. The image sensor of claim 10, wherein, among the first width, the second width, and the third width, the first width is the greatest, and the second width is the smallest.

15. The image sensor of claim 1, the image sensor being configured to:
generate one luminance signal by adding all of an output of the red pixel, outputs of the two green pixels, and an output of the blue pixel;
generate a first color signal by subtracting the outputs of the two green pixels from the output of the blue pixel; and
generate a second color signal by subtracting the outputs of the two green pixels from the output of the red pixel, in the first unit of each of the plurality of unit pixel groups.

16. The image sensor of claim 15, wherein, the luminance signal, the first color signal, and the second color signal are generated without performing demosaicing processing on the output of the red pixel, the outputs of the two green pixels, and the output of the blue pixel, in the first unit of each unit pixel group of the plurality of unit pixel groups.

17. An electronic apparatus comprising:
a lens assembly configured to form an optical image of an object;
an image sensor configured to convert the optical image formed by the lens assembly into an electrical signal; and
a processor configured to process a signal generated by the image sensor,
wherein the image sensor comprises:
a sensor substrate comprising a plurality of unit pixel groups in two dimensions in a first direction and a second direction, each unit pixel group of the plurality of unit pixel groups comprising a plurality of pixels configured to detect light; and
an optical element arranged on the sensor substrate and focusing incident light onto each pixel of the plurality of pixels, and
wherein each unit pixel group of the plurality of unit pixel groups comprises:
a first unit comprising a red pixel, two green pixels, and a blue pixel, which are in a 2×2 format in the first direction and the second direction, the two green pixels being adjacent to each other in a diagonal direction;
a second unit having a structure of the first unit rotated by 90 degrees with respect to a third direction perpendicular to the first direction and the second direction as an axis of rotation;
a third unit having a structure of the first unit rotated by 180 degrees with respect to the third direction as an axis of rotation; and
a fourth unit having a structure of the first unit rotated by 270 degrees with respect to the third direction as an axis of rotation.

18. The electronic apparatus of claim 17, wherein the image sensor is further configured to:
generate one luminance signal by adding all of an output of the red pixel, outputs of the two green pixels, and an output of the blue pixel;
generate a first color signal by subtracting the outputs of the two green pixels from the output of the blue pixel; and
generate a second color signal generated by subtracting the outputs of the two green pixels from the output of the red pixel, in the first unit of each of the plurality of unit pixel groups.

19. The electronic apparatus of claim 18, wherein the image sensor is further configured to generate the luminance signal, the first color signal, and the second color signal without performing demosaicing processing on the output of the red pixel, the outputs of the two green pixels, and the output of the blue pixel, in the first unit of each unit pixel group of the plurality of unit pixel groups.

20. The electronic apparatus of claim 17, wherein the red pixel comprises a red photodiode configured to selectively absorb light of a red wavelength band and has a first width in one or the first direction and the second direction,
wherein each green pixel among the two green pixels comprises a green photodiode configured to selectively absorb light of a green wavelength band and has a second width in one of the first direction and the second direction,
wherein the blue pixel comprises a blue photodiode configured to selectively absorb light of a blue wavelength band and has a third width in one of the first direction and the second direction, and
wherein at least two widths among the first width, the second width, and the third width are different from each other.
